(19) United States
(12) Patent Application Publication
(10) Pub. No.: US 2026/0277668 A1
(43) Pub. Date: Sep. 17, 2026

(54) DEPLOYING AUTONOMOUS SOFTWARE AGENTS TO EXECUTE SOFTWARE TASKS UTILIZING CONNECTED CODE REPOSITORIES

(71) Applicant: COGNITION AI, INC., San Francisco, CA (US)

(72) Inventors: Tony Jiang, Sunnyvale, CA (US); Scott Wu, Atherton, CA (US); Steven Hao, Atherton, CA (US); Sampriti Panda, Menlo Park, CA (US); Walden Yan, Atherton, CA (US); Adhyyan Sekhsaria, San Francisco, CA (US); Jeffrey Ling, Redwood City, CA (US)

(21) Appl. No.: 19/561,185

(22) Filed: Mar. 9, 2026

Related U.S. Application Data
(60) Provisional application No. 63/770,816, filed on Mar. 12, 2025.

(51) Int. Cl. G06F 9/48

(52) U.S. Cl. CPC G06F 9/4881

(57) ABSTRACT

The present disclosure relates to systems, methods, and non-transitory computer-readable media that deploys an autonomous software agent to generate artificial intelligence outputs responsive to the software task based on accessing the one or more code repositories. In particular, the disclosed systems connect an autonomous software agent system with a computer code repository management system. Moreover, the disclosed systems receive a prompt to deploy an autonomous software agent, and the disclosed systems deploy the autonomous software agent within an independent virtual machine computing environment to execute a software task by accessing one or more connected code repositories. Additionally, the disclosed systems generate artificial intelligence outputs based on accessing the connected code repositories.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital co-pilot assistants. Over time, computing systems have been developed that generate computer code to assist (e.g., in a co-pilot like manner) a software developer in completing their computer tasks. For instance, some existing systems can assist software developers in generating code by supplementing computer code or making tweaks to existing computer code. Despite these advances, however, existing systems continue to suffer from a number of disadvantages, particularly in terms of computational efficiency, technical accuracy, and operational flexibility.

### SUMMARY

One or more embodiments described herein provide benefits and/or solve one or more problems in the art with systems, methods, and non-transitory computer-readable media that deploy autonomous software agents and execute software tasks based on accessing a connected code repository part of a code repository management system. To illustrate, in one or more embodiments, the disclosed systems connect an autonomous software agent system with a computer code repository management system. Moreover, in one or more embodiments, the disclosed systems receive a request to activate an autonomous software agent and as part of the request, receive a software task. Specifically, in response to the request, the disclosed systems deploy an autonomous software agent to perform the software task (e.g., generate computer code, create an application end-to-end, fine-tune an artificial intelligence model, debug computer code, etc.).

In one or more embodiments, the disclosed systems generate one or more artificial intelligence outputs responsive to executing the software task. In some embodiments, the disclosed systems generate the one or more artificial intelligence outputs by accessing one or more code repositories based on a connection between the autonomous software agent system and the code repository management system.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an autonomous software agent system connecting with a code repository management system in accordance with one or more implementations;

FIG. 2 illustrates an example diagram of the autonomous software agent system receiving different types of access permissions to a connected code repository management system in accordance with one or more implementations;

FIG. 3 illustrates an example diagram of the autonomous software agent system receiving access to a subset of code repositories and generating artificial intelligence outputs in accordance with one or more implementations;

FIG. 4 illustrates an example diagram of the autonomous software agent system deploying an autonomous software agent that accesses a plurality of software composition tools in accordance with one or more implementations;

FIGS. 5A-5H illustrate example graphical user interfaces of the autonomous software agent system connecting with a code repository management system in accordance with one or more implementations;

FIG. 6 illustrates an example diagram of an architectural layer design of the autonomous software agent system which accesses various artificial intelligence models to enable an independent virtual machine computing environment of an autonomous software agent in accordance with one or more implementations;

FIG. 7 illustrates an example diagram of a virtual private cloud housing an independent virtual machine computing environment that is in communication with an autonomous agent model backend in accordance with one or more implementations;

FIG. 8 illustrates an example diagram of a frontend layer interacting with an autonomous software agent system ingestion layer and a virtual private cloud in accordance with one or more implementations;

FIG. 9 illustrates an example environment of the autonomous software agent system in accordance with one or more implementations;

FIG. 10 illustrates an example series of acts for generating artificial intelligence outputs based on accessing one or more connected code repositories in accordance with one or more implementations; and

FIG. 11 illustrates a block diagram of an exemplary computing device in accordance with one or more implementations.

### DETAILED DESCRIPTION

One or more embodiments described herein includes an autonomous software agent system that connects with a computer code repository management system to generate artificial intelligence outputs by accessing one or more code repositories. To illustrate, in one or more embodiments, an autonomous software agent system 100 integrates with a computer code repository management system that contains a plurality of code repositories. In some embodiments, the autonomous software agent system 100 receives repository access to a specific set of code repositories of the computer code repository management system. In addition, in some embodiments, the autonomous software agent system 100 receives different levels of access (e.g., read access or write access) for an autonomous software agent to read or write computer code.

In some embodiments, the autonomous software agent system 100 deploys an autonomous software agent to independently complete software development tasks such as writing computer code tests, adding features to an existing code repository, adding functionality to an existing codebase, developing prototypes, and building integrations between software applications. In one or more embodiments, the autonomous software agent system 100 utilizes an autonomous software agent to execute a task/sub-task of a software task by accessing relevant code repositories that are connected with the autonomous software agent system 100. In particular, the autonomous software agent system 100 customizes an independent virtual machine computing environment and the autonomous software agent is enabled to access customized code repositories that are part of a code repository management system.

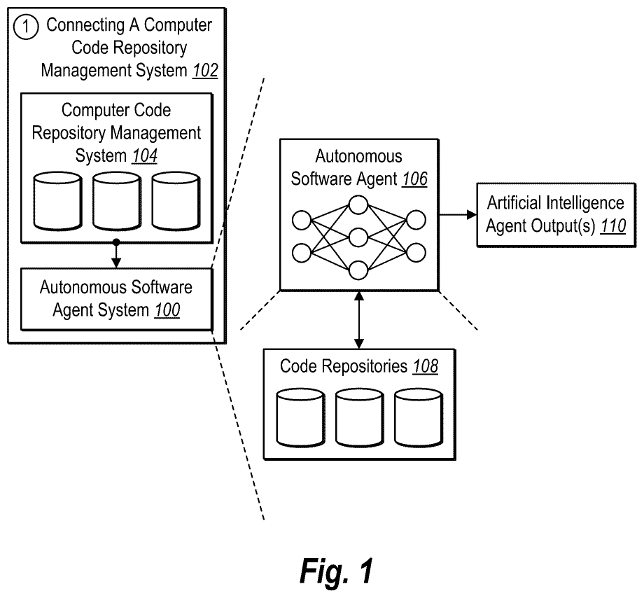

FIG. 1 illustrates an overview diagram of the autonomous software agent system 100 connecting with a code repository management system in accordance with one or more embodiments. For example, FIG. 1 shows the autonomous software agent system 100 performing an act 102 of connecting with a computer code repository management system 104. In one or more embodiments, connecting the computer code repository management system 104 with the autonomous software agent system 100 refers to an integration with an external application. For example, the connection between the autonomous software agent system 100 and the computer code repository management system 104 refers to an integration that allows the autonomous software agent system 100 to read, write, or manage repositories, manage issues, manage pull requests, and manage related documentation within the computer code repository management system 104.

In one or more embodiments, the connection requires authentication and authorization. In particular, the connection utilizes access credentials, API keys, OAuth (tokens that expire and refresh), and signed requests. Furthermore, the autonomous software agent system 100 receives different levels of access such as read-only access to repositories, and write access to repositories (e.g., push code, create branches, etc.). Additionally, the autonomous software agent system 100 can receive access levels scoped at a repository level, an organization level, and/or specific features (e.g., code features, issues, actions).

In one or more embodiments, the connection between the autonomous software agent system 100 and the computer code repository management system 104 allows an autonomous software agent to clone code repositories (e.g., download), browse code and documentation (e.g., README, wikis), pulling updates, submitting pull requests, and reviewing computer code. Further, in some embodiments, the connection between the autonomous software agent system 100 and the computer code repository management system 104 allows an autonomous software agent to have documentation access and application programming interface access.

In one or more embodiments, integration between the autonomous software agent system 100 and the computer code repository management system 104 is implemented using an application installation model. For example, the autonomous software agent system 100 registers as a platform application and is installed into one or more repositories or organization accounts. Upon installation, the platform assigns an installation identifier corresponding to a repository or organization scope. The autonomous software agent system 100 generates a signed JSON Web Token (JWT) using a private key associated with the registered application and exchanges the signed JWT for a time-limited installation access token. The installation access token is then utilized to perform repository-scoped operations including reading repository contents, creating branches, committing changes, and creating pull requests. In some embodiments, installation tokens are short-lived and automatically refreshed, thereby limiting persistent credential exposure.

In one or more embodiments, the computer code repository management system 104 refers to a collaborative software environment where software developer computing devices (e.g., user computing devices) access, build, test, and deploy computer code software for a unified platform. In particular, the computer code repository management system 104 can include source code, code repositories (e.g., code libraries), and code documentation. Moreover, when a software developer computing device adds/modifies computer code in the computer code repository management system 104, the software developer computing device can track changes made to the code (e.g., leave comments).

As is just mentioned, the computer code repository management system 104 includes one or more code repositories. In one or more embodiments, a code repository refers to a centralized location where software computer code is stored, managed, and controlled (e.g., controlled for different deployment versions such as development, web application, cloud, etc.). In particular, the code repository includes computer code, computer code documentation (e.g., files explaining how to use, setup, and contribute to one or more projects), configuration files (e.g., environment configuration, application configuration, deployment configuration, etc.), and assets (e.g., images, CSS files, JavaScript files, fonts, external libraries, audio/video files, etc.).

In some embodiments, software applications/systems utilize one or more code repositories to organize computer code, collaborate on computer code projects, and maintain computer code over time. In other words, a code repository enables multiple software developer computing devices to collaborate on computer code projects (e.g., software development teams can upload and download changes to and from the code repository) by creating branches to work on specific features or computer code bugs. Once a branch is completed, software developer computing devices can merge their changes into the code repository (e.g., which results in other software developer computing devices with access to the code repository being able to access the changes).

In one or more embodiments, the autonomous software agent system 100 further performs an act of deploying an autonomous software agent 106 (e.g., a cloned virtual machine that is isolated and can perform tasks siloed from other virtual machine computing devices). In particular, the autonomous software agent system 100 deploys the autonomous software agent 106 within an independent virtual machine computing environment and generates and runs code in its own isolated environment.

In one or more embodiments, the independent virtual machine computing environment refers to a software-based simulation that independently runs its own operating system and applications as a standalone machine. For example, a virtual machine computing environment refers to a software-implemented computational environment that emulates a physical computing system and provides an isolated, executable runtime environment for code generation, execution, testing, modification, or orchestration by the autonomous software agent system 100. In one or more embodiments, the virtual machine computing environment may operate as a system-level virtualization layer (e.g., hypervisor-based virtual machine), an operating system-level container, a language runtime virtual machine, or a custom execution sandbox, and may be dynamically provisioned, configured, and decommissioned under control of the virtual machine computing environment.

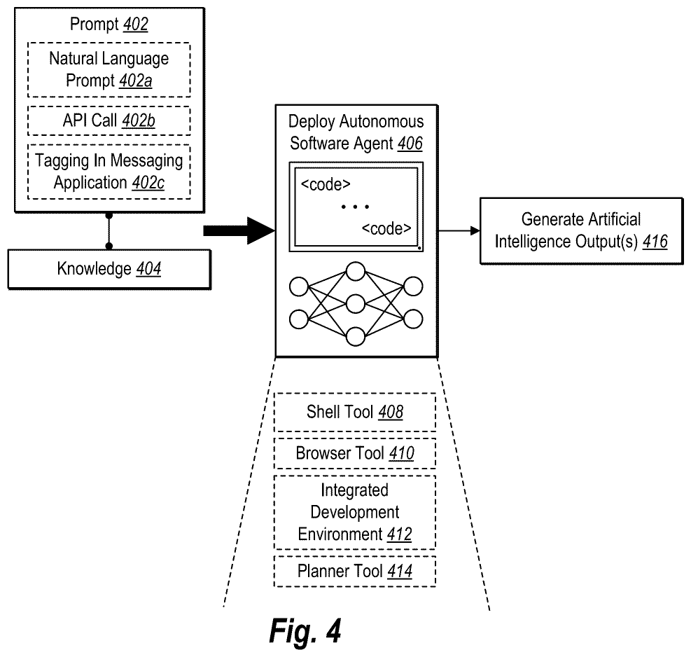

In other words, the autonomous software agent 106 exists independently of a computing device of a user who submitted a prompt to deploy the autonomous software agent 106 and performs tasks based on knowledge that is provided to it. Moreover, the autonomous software agent system 100 further provides to the autonomous software agent 106, computer software composition tools. Details pertaining to the computer software composition tools are given in more detail below in the description of FIG. 4.

In one or more embodiments, the autonomous software agent system 100 provides the autonomous software agent 106 with its own software development environment (e.g., the independent virtual machine computing environment with access to the computer software composition tools) to perform individualized tasks and not merely supplementary tasks (e.g., the autonomous software agent 106 can deploy its own codebase by replicating an existing codebase, make changes to an existing codebase, implement changes to a codebase, and run tests for computer code generated by the autonomous software agent 106).

In some embodiments, the autonomous software agent 106 includes a set of artificial intelligence models. In particular, the autonomous software agent 106 includes one or more machine learning models, neural networks, large language models, chain-of-thought reasoning models, and/or vision-language models. Thus, the autonomous software agent system 100 deploys the autonomous software agent 106 that operates within an independent virtual machine computing device with various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, a language model includes a set of statistical or probabilistic functions to perform Natural Language Processing (NLP) in order to understand, learn, and/or generate human natural language content. For example, the autonomous software agent system 100 uses a language model as a tool that determines the probability of a given sequence of words occurring in a sentence or natural language sequence. Simply put, the autonomous software agent system 100 uses a model that is trained to predict the next word in a sentence.

A language model is called a large language model (LLM) when it is trained on an enormous amount of data (e.g., a threshold amount of data) and/or has a large number of parameters. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system 100 employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

Additionally, FIG. 1 shows the autonomous software agent system 100 performing an act of accessing code repositories 108 based on a connection with the computer code repository management system 104. In particular, the autonomous software agent system 100 utilizes the autonomous software agent 106 to access the code repositories 108 and/or software composition tools discussed below to generate artificial intelligence output(s) 110 (e.g., computer code, terminal commands, terminal command outputs, an artificial intelligence plan, and/or progress status updates for a software task).

As mentioned above, existing systems are inefficient. For example, existing systems provide code generation assistant features to assist a developer in completing their software tasks. However, these existing systems merely supplement developer work. In particular, existing systems require heavily involved guidance, prompting, monitoring, and the use of a developer's device in order to supplement developer work. In other words, existing systems merely act as a co-pilot to a developer. Accordingly, existing systems suffer from computational inefficiencies of attempting to integrate a code development assistant into a developer's workflow and often suffer from being prompted and re-prompted to yield satisfactory results (e.g., which results in wasted computational resources).

In addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, and/or logical errors.

In particular, existing systems may be able to generate computer code to supplement a developer's task, however it is often difficult or impossible to follow/understand the thought process of existing code generation systems writing computer code. Often, existing code generation systems are a black box that receive instructions and output computer code (e.g., which results in difficulties understanding how the existing code generation system arrived at its answer). As such, modifying intermediate steps of a (supplementary) software coding task performed by existing code generation systems are often infeasible.

Relatedly, existing systems suffer from operational inflexibility. Because existing systems are limited to supplementing code development for cases expressly coded by engineers, these existing systems fail to adapt to creating new computer code, tackling complex non-trivial tasks, correctly understanding already generated computer code and/or effectively performing tests on computer code. Indeed, the inflexible nature of existing systems severely hampers the ability of existing systems to keep up with the taxing demands of software development from a holistic perspective. In other words, existing systems are stuck operating as a co-pilot developer to merely supplement a software developer's workflow.

In one or more embodiments, the autonomous software agent system 100 provides several improvements over conventional systems in relation to technical accuracy, computational efficiency, and operational flexibility. In contrast to existing systems, which require heavily involved guidance, prompting, monitoring, and the use of a developer's device (in order to supplement developer work), the autonomous software agent system 100 deploys an autonomous software agent that operates as an independent virtual machine computing device.

In doing so, the autonomous software agent system 100 allows for an autonomous software agent to operate independently to solve non-trivial tasks, and it does not conflate or confuse the context of other ongoing tasks. Specifically, the autonomous software agent system 100 silos/isolates autonomous software agents (e.g., to operate independently with fully featured computer software composition tools discussed in more detail in FIG. 4) such that the autonomous software agents can accurately perform their assigned software tasks without being bogged down by additional information.

In one or more embodiments, the autonomous software agent system 100 further improves upon technical inaccuracies by connecting with a code repository management system. In particular, the autonomous software agent system 100 can integrate with a code repository management system and gain read/write access to various code repositories stored within the code repository management system.

In doing so, the autonomous software agent system 100 improves the technical accuracy of the autonomous software agent executing a software task. In particular, the autonomous software agent system 100 provides the autonomous software agent with access to the code repository management system which includes computer code documentation, access to internal/private code libraries, access to contextual tips for operating within the internal code libraries, and/or access to skills. In other words, the autonomous software agent system 100 accesses elements within the code repository management system which improves the success rate of executing a software task (e.g., specialized skills, contextual tips, or access to specific sources assist the autonomous software agent in more accurately accomplishing a software task).

In one or more embodiments, the autonomous software agent system 100 further improves upon technical inaccuracies. In contrast to existing systems, which are often incomplete or inadequate in generating complex and extensive computer code, the autonomous software agent system 100 deploys an autonomous software agent that uses an intelligent orchestration process to determine how to understand a relevant code repository/environment (e.g., via a connected code repository management system), how to generate artificial intelligence outputs (e.g., computer code) that match a determined context (e.g., as indicated by a context of the code repository management system), and how to choose between various artificial intelligence models to accomplish various software tasks. In some embodiments, the autonomous software agent system 100 allows a user of a computing device to configure an autonomous software agent environment (e.g., via providing customized access to a code repository management system) and then deploys the autonomous software agent to complete a software task, thus improving the technical accuracy of artificial intelligence agents performing software tasks (e.g., relative to existing systems).

In one or more embodiments, the autonomous software agent system 100 enables a user computing device to follow the work of an autonomous software agent as it performs a software coding task. For example, the autonomous software agent system 100 displays commands submitted by the autonomous software agent via a terminal, computer code being written by the autonomous software agent via an editor, and computer code being debugged by the autonomous software agent. As such, the autonomous software agent system 100 enables a user of a computing device to more accurately understand the manner in which an autonomous software agent arrived at a final result (e.g., the user computing device can follow the autonomous software agent in real-time).

Relatedly, the autonomous software agent system 100 also improves computational efficiency of software tasks by enabling options for a user of a computing device to follow an autonomous software agent executing a software task. In particular, as mentioned, the autonomous software agent can operate independently, and in some instances, a user can intervene or understand the steps/thought processes of an autonomous software agent by following the autonomous software agent as it switches between using different computer software composition tools.

In particular, a user of a computing device can follow an autonomous software agent as it switches between different computer software composition tools to execute a software task. In doing so, the autonomous software agent system 100 saves computational resources and time as a user can more efficiently understand the process of an autonomous software agent (e.g., as it performs a task or after it performs a task) and the user can intervene at one or more points in the development session to aid/assist an autonomous software agent.

Moreover, in some embodiments, the autonomous software agent system 100 prompts (e.g., via a chat interface) a user computing device to provide additional access to an autonomous software agent to more accurately execute a sub-task of a software task. In particular, from executing a software task, the autonomous software agent system 100 can identify certain inputs that require additional access permissions and suggest a user computing device to provide additional access permissions (e.g., read access for a specific code repository). In doing so, the autonomous software agent system 100 improves the technical accuracy of development sessions by drawing from inputs that were helpful in successful in accomplishing a previous software task.

Furthermore, the autonomous software agent system 100 improves computational efficiency by enabling a user computing device to continue to delegate entire non-trivial software coding tasks to the autonomous software agent while the autonomous software agent is already working completely asynchronously. As the autonomous software agent is executing a software coding task, a user can delegate multiple additional autonomous software agents to perform additional software tasks. Thus, the autonomous software agent system 100 enables large scale parallelization of tasks.

In one or more embodiments, the autonomous software agent system 100 further improves upon operational inflexibilities. In contrast to existing systems, which are rigidly tied to code supplementation, the autonomous software agent system 100 deploys an autonomous software agent that operates within an independent virtual machine computing environment and further allows a user to monitor/modify the progress of the autonomous software agent (if so desired). Moreover, because the autonomous software agent system 100 deploys an autonomous software agent that is provided with various development box tools, the autonomous software agent acts as an advanced reasoning tool to complete non-trivial tasks. Accordingly, the autonomous software agent system 100 enhances the flexibility of operations in performing code generation tasks relative to existing systems.

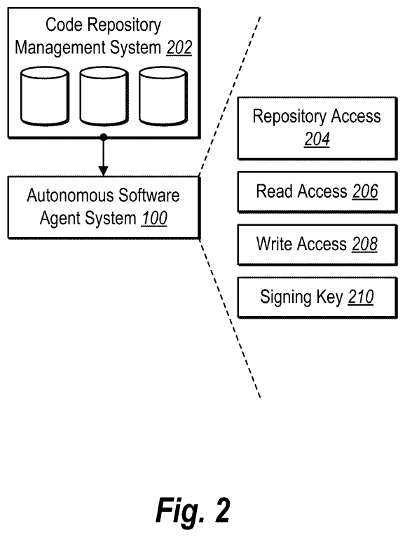

FIG. 2 illustrates the autonomous software agent system 100 connecting with a code repository management system and various granted permissions in accordance with one or more embodiments. For example, FIG. 2 shows the autonomous software agent system 100 connecting with a code repository management system 202. In particular, as part of the connection, the autonomous software agent system 100 can receive repository access 204, read access 206, write access 208, and a signing key 210.

In one or more embodiments, the repository access 204 refers to permission for the autonomous software agent system 100 to view and/or interact with a specific set of code repositories stored within the code repository management system 202. In particular, the autonomous software agent system 100 receives a selection of one or more code repositories within the code repository management system 202 and receives permission to access the selected one or more code repositories.

In one or more embodiments, the read access 206 refers to permissions for the autonomous software agent system 100 to view repository contents that are connected via the code repository management system 202. In some embodiments, the read access 206 refers to permissions for the autonomous software agent system 100 to view code and documentation, clone or pull a repository, read commit history, issues, and pull requests. In other words, the read access 206 does not allow the autonomous software agent system 100 to push code, modify files, merge pull requests, and change repository settings with the code repository management system 202 connected with the autonomous software agent system 100.

In one or more embodiments, the write access 208 refers to permissions for the autonomous software agent system 100 to modify repository contents (e.g., contribute to connected code repositories). For example, the write access 208 refers to permissions that allow the autonomous software agent system 100 to push code changes, create and delete branches, open and update pull requests, modify files and documentation. In some embodiments, the write access 208 contains different levels of permission. For example, the write access 208 can include restrictions on merging computer code to protected branches within a code repository. Further, in some embodiments, the write access 208 can include reviews or approvals by a software developer before an autonomous software agent can merge computer code.

In one or more embodiments, the signing key 210 refers to a cryptographic key used to prove the authenticity and integrity of commits, tags, comments, changes, etc. For example, the signing key 210 refers to a cryptographic key of an autonomous software agent performing a software task. In particular, the autonomous software agent utilizes the signing key 210 to sign commits or tags within the code repository management system 202.

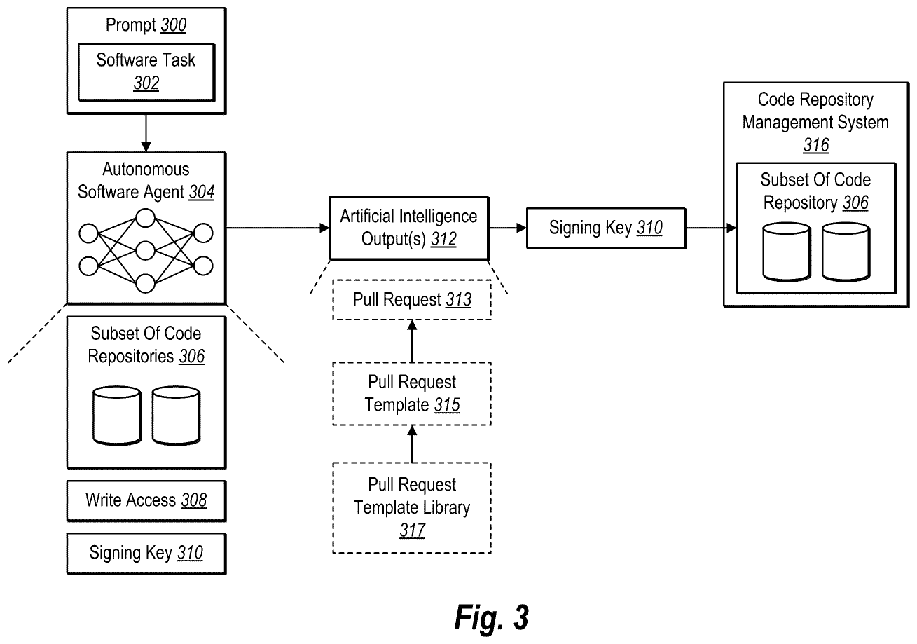

FIG. 3 illustrates the autonomous software agent system 100 generating an artificial intelligence output in accordance with one or more embodiments. For example, FIG. 3 shows the autonomous software agent system 100 receiving/accessing a prompt 300 that includes a software task 302. In one or more embodiments, the prompt 300 refers to a natural language prompt (from a user computing device), an application programming interface call, and/or a tag/mention in a third-party messaging application received by the autonomous software agent system 100. In one or more embodiments, the prompt refers to a request, a question, or an instruction submitted by a user of a user account corresponding to a computing device (e.g., a user computing device). In particular, the prompt 300 can include text instructions and/or image data received from a user computing device. The specific details relating to the prompt 300 being an application programming interface call or a tag/mention are given below in the description of FIG. 4.

Furthermore, FIG. 3 shows the autonomous software agent system 100 deploying an autonomous software agent 304 to execute the software task 302 that is included within the prompt 300. In one or more embodiments, the software task 302 refers to a defined unit of work in a software project to be planned, assigned, executed and/or completed. For example, the software task 302 refers to a specific software component for the autonomous software agent system 100 to build, change, fix, and/or maintain based on requirements of the prompt 300. In other words, the software task 302 refers to a discrete, actionable piece of work that contributes to the development, maintenance, or improvement of a software system. More specifically, a software task refers to a defined computational objective, instruction set, or problem specification that can be satisfied through the generation, modification, execution, analysis, or orchestration of computer-executable code by an artificial intelligence (AI) code-writing agent.

A software task may be expressed in natural language, structured prompts, formal specifications, source code fragments, test cases, API definitions, configuration files, user stories, or any combination thereof. In one or more embodiments, a software task defines one or more functional, logical, structural, or performance requirements that constrain or guide code generation or transformation. For example, a software task may include, without limitation: generating source code implementing specified functionality; translating code between programming languages or frameworks; completing partial code segments; refactoring, optimizing, or modifying existing code; debugging code based on error messages, stack traces, or failing tests; generating unit tests, integration tests, or documentation; constructing data pipelines, scripts, or infrastructure definitions; performing static or dynamic analysis and producing corrective modifications; or orchestrating multi-step development workflows involving code synthesis and validation.

In one or more embodiments, a software task may further include associated constraints such as target programming language, runtime environment, library dependencies, security policies, performance thresholds, coding standards, or interface requirements. In some embodiments, a software task may be decomposed into subtasks, iteratively refined, validated against automated test harnesses, or dynamically modified based on intermediate execution results. The autonomous software agent system 100 may autonomously interpret, prioritize, sequence, and execute one or more software tasks within a broader development objective. Unless expressly limited, a software task encompasses any machine-interpretable or human-specified objective that can be fulfilled, in whole or in part, through automated code generation or code manipulation.

As shown in FIG. 3, the autonomous software agent system 100 utilizes the autonomous software agent 304 to access a subset of code repositories 306. In particular, the autonomous software agent system 100 connects with a code repository management system 316 and accesses the subset of code repositories 306 as part of executing the software task 302. In some embodiments, the autonomous software agent system 100 determines that the software task 302 involves software tasks within the subset of code repositories 306 (e.g., based on an artificial intelligence plan discussed in more detail below).

Additionally, FIG. 3 shows the autonomous software agent system 100 providing write access 308 to the autonomous software agent 304. In particular, the write access 308 to the autonomous software agent 304 allows the autonomous software agent 304 to push code changes, create and delete branches, open and update pull requests, modify files and documentation within the subset of code repositories 306 (e.g., or additional code repositories within the code repository management system 316 if the autonomous software agent 304 was given write access to those additional code repositories).

Furthermore, FIG. 3 shows the autonomous software agent system 100 providing a signing key 310 to the autonomous software agent 304. As mentioned above, the signing key 310 is a cryptographic key used to prove the authenticity and integrity of commits, tags, comments, and changes performed by the autonomous software agent 304. In other words, for tasks such as pushing code changes, creating and deleting branches, opening and updating pull requests, modifying files and documentation within the subset of code repositories 306, the autonomous software agent 304 utilizes the signing key 310 (e.g., the signing key 310 helps software developers part of the code repository management system 316 to trace any changes/commits made by the autonomous software agent 304).

As shown in FIG. 3, the autonomous software agent system 100 utilizes the autonomous software agent 304 to generate artificial intelligence output(s) 312. As mentioned above, the artificial intelligence output(s) 312 include computer code, terminal commands, terminal command outputs, an artificial intelligence plan, and/or progress status updates for a software task.

Moreover, in some embodiments, the autonomous software agent 304 executes the software task 302 and generates the artificial intelligence output(s) 312 that are proposed changes to the subset of code repositories 306. In particular, the autonomous software agent system 100 can utilize the autonomous software agent 304 to generate a pull request 313. For example, the pull request 313 refers to a structured way to propose, review, discuss and merge changes from one branch of a code repository into another (e.g., a main or default branch). In some embodiments, the autonomous software agent 304 generates the pull request 313 (e.g., containing written computer code based on accessing the subset of code repositories) and submits the pull request 313 for a software developer to approve and merge into a target branch.

In one or more embodiments, the pull request 313 includes a source branch and a target branch. In particular, a source branch refers to where the changes drafted by the autonomous software agent 304 are housed. Further, the target branch refers to where the changes drafted by the autonomous software agent 304 should be placed. Moreover, in some embodiments, the pull request 313 includes a set of code changes such as added, modified, or deleted files, code updates, documentation changes, and/or configuration changes.

Additionally, in some embodiments, the autonomous software agent 304 generates the pull request 313 and submits it to the code repository management system 316. In particular, in some instances, the pull request 313 is designed for collaboration between a plurality of software developers' part of the code repository management system 316. For instance, software developers can leave inline comments on specific lines of code, ask questions, request changes, suggest improvements, and approve or reject changes. In response to feedback from software developers on a pull request generated by the autonomous software agent 304, the autonomous software agent 304 can further iterate on the software task 302 (e.g., in an additional development session) to incorporate the feedback.

In one or more embodiments, the autonomous software agent system 100 utilizes the autonomous software agent 304 to access a pull request template 315. For example, the autonomous software agent system 100 utilizes the autonomous software agent 304 to generate computer code or other outputs and further identifies existing pull requests corresponding to the subset of code repositories 306. In other words, the autonomous software agent system 100 identifies existing pull requests to use as templates for generating another pull request. Accordingly, the autonomous software agent system 100 selects the pull request template 315 (e.g., from a plurality of pull request templates) and generates the pull request 313 (e.g., based on the artificial intelligence output(s) 312). Additionally, in some embodiments, the autonomous software agent system 100 utilizes the autonomous software agent 304 to submit the pull request 313 to the code repository management system 316.

In one or more embodiments, the autonomous software agent system 100 generates a pull request template library 317. For example, the autonomous software agent system 100 connects with the code repository management system 316, extracts a plurality of existing pull requests from the code repository management system 316, and generates the pull request template library 317. In response to the autonomous software agent 304 executing the software task 302 that includes generating the pull request 313, the autonomous software agent system 100 searches within the pull request template library 317 to identify a similar pull request for the current software task.

In some embodiments, the autonomous software agent system 100 provides an option for a user computing device to submit a custom pull request template. In particular, the autonomous software agent system 100 provides an option to submit a custom pull request template without the autonomous software agent system 100 modifying a user-facing template (e.g., utilized by one or more users connected with a code repository management system). For example, the autonomous software agent system 100 can receive a custom pull request template named devin_pr_template.md. In particular, the autonomous software agent system 100 can create a pull request template library that includes a plurality of template categories (e.g., custom-agent pull request templates, pull request templates within code repository documentation, existing pull requests, etc.).

To illustrate, the autonomous software agent system 100 can generate pull request template categories for the pull request template library 317 that includes the following:

1. PULL_REQUEST_TEMPLATE/devin_pr_template.md
2. docs/ PULL_REQUEST_TEMPLATE/devin_pr_template.md
3. .github/PULL_REQUEST_TEMPLATE/devin_pr_template.md
4. pull_request_template.md
5. docs/pull_request_template.md
6) .github/pull_request_template.md

In particular, the autonomous software agent system 100 can search for templates within the pull request template library 317 in the above-established order and uses a first match to identify the pull request template 315. In other words, the above-established order indicates a hierarchy of starting with agent-designated templates for the autonomous software agent system 100 and then other templates that exist within a connected code repository. For example, the autonomous software agent system 100 can leverage the artificial intelligence output(s) 312 (e.g., generated by the autonomous software agent 304) and compare (e.g., in an embedding space) the artificial intelligence output(s) 312 with each of the pull request template categories (e.g., starting with custom-agent pull request templates as indicated in the established order).

In some embodiments, the autonomous software agent system 100 leverages a pull request template to access additional context for creating a pull request, such as a reviewer checklist or a diagram for modified files. In other words, the autonomous software agent system 100 can intelligently adjust to tailoring the pull request 313 to user-specified requirements. In doing so, the autonomous software agent system 100 can generate the pull request 313 based on the artificial intelligence output(s) 312 that also includes additional context as indicated by user-specified requirements. Moreover, in some embodiments, if the autonomous software agent system 100 is unable to locate a relevant pull request template, the autonomous software agent system 100 can use a default pull request description format.

In one or more embodiments, upon committing changes to a task-specific branch, the autonomous software agent system 100 programmatically generates a pull request targeting a base branch of the repository. The autonomous software agent system 100 may populate a pull request title and body using a structured template that references the associated task, issue identifier, or session context. During execution, the autonomous software agent system 100 may update the pull request with additional commits, modify the pull request description, or transition the pull request between draft and ready-for-review states. In some embodiments, the autonomous software agent system 100 parses repository issue references and automatically links or closes issues based on predefined keywords.

FIG. 3 shows the autonomous software agent system 100 utilizing the autonomous software agent 304 to generate the artificial intelligence output(s) 312 and further utilizing the signing key 310. As discussed above, the signing key 310 acts as an identity authentication/tracing mechanism such that software developers of the code repository management system 316 understand/know that the autonomous software agent 304 generated the artificial intelligence output(s) 312. As shown in FIG. 3, the autonomous software agent system 100 utilizes the autonomous software agent 304 to provide the artificial intelligence output(s) 312 to the subset of code repositories 306 that are part of the code repository management system 316.

FIG. 4 illustrates an overview of the autonomous software agent system 100 generating artificial intelligence outputs by deploying an autonomous software agent in accordance with one or more embodiments. For example, FIG. 4 shows the autonomous software agent system 100 accessing/receiving a prompt 402. In particular, the prompt 402 refers to a natural language prompt 402a (from a user computing device), an application programming interface call 402b, and/or a tag/mention 402c in a messaging application.

In some embodiments, via an API, a user computing device can build custom workflows using an API of the autonomous software agent system 100 and programmatically assign tasks for the autonomous software agent system 100 to perform. Further, with the API, users of computing devices can essentially plug in the autonomous software agent system 100 to any of their software development and internal tools.

In some embodiments, the autonomous software agent system 100 deploys an autonomous software agent in response to being triggered by a code editor. In particular, from another code editor/integrated development environment (IDE), users of computing devices who use visual studio code (or visual studio code forks) can assign tasks to the autonomous software agent system 100 directly from their code editor/IDE.

In some embodiments, the autonomous software agent system 100 can deploy an autonomous software agent in response to being tagged/mentioned in a third-party messaging application. In particular, users of computing devices can tag the autonomous software agent system 100 directly from conversations they are having with colleagues in the third-party messaging application. Furthermore, the autonomous software agent system 100 will reply directly in the messaging thread and anyone can jump into the thread and provide further instructions to the autonomous software agent system 100.

In some embodiments, the autonomous software agent system 100 integrated with a third-party messaging application further includes a centralized server. In particular, the autonomous software agent system 100 utilizes a centralized server that is responsible for forwarding information between the autonomous software agent system 100 and the messaging application. To illustrate, a user computing device can install a messaging integration for the autonomous software agent system 100 into a messaging workspace and further add the integration to the relevant channels of a messaging application.

In some embodiments, if the autonomous software agent system 100 receives a tag/mention of an autonomous software agent in the messaging application, then the autonomous software agent system 100 utilizes a centralized server to recognize the tag/mention. Furthermore, the autonomous software agent system 100 passes that tag/mention along to a web server backend that a website hosted by the autonomous software agent system 100 uses to start a new session (e.g., initiate an autonomous software agent for deployment).

As further shown in FIG. 4, the autonomous software agent system 100 further accesses/receives knowledge 404. In particular, the knowledge 404 can include a development environment, guidelines, code repositories, and/or one or more software tasks from the knowledge library discussed above. In some embodiments, the knowledge 404 refers to a form of “information” (e.g., knowledge inputs) that allows the autonomous software agent system 100 to retrieve information based on specific triggers that might be relevant to a session of the autonomous software agent.

As further shown in FIG. 4, the autonomous software agent system 100 further performs an act 406 of deploying an autonomous software agent (e.g., a cloned virtual machine that is isolated and can perform tasks siloed from other devices). Moreover, as shown in FIG. 4, the autonomous software agent system 100 further provides to the autonomous software agent a shell tool 408, a browser tool 410, an integrated development environment (IDE) 412, and a planner tool 414.

For example, a shell tool 408 refers to an interface layer that mediates interaction between an artificial intelligence (AI) agent and an underlying execution environment, computing system, development environment, or virtualized runtime. The shell tool 408 provides a structured command, control, and input/output framework through which the autonomous software agent system 100 issues instructions, receives responses, and orchestrates software development operations. A shell tool 408 may comprise a command-line interpreter, application programming interface (API) interface, remote procedure call (RPC) interface, messaging interface, terminal emulator, container interface, virtual machine interface, or any combination thereof. The shell tool 408 abstracts underlying system resources—including file systems, process control, compilers, interpreters, debuggers, network interfaces, and package managers—and presents a controllable operational surface to the autonomous software agent system 100.

As used herein, a browser tool 410 (or simply browser) refers to a software component executing within an independent virtual machine computing environment and configured to retrieve, render, interpret, and interact with network-accessible resources on behalf of an autonomous software agent system 100. A browser tool 410 operates as a controlled network interaction interface within the independent virtual machine computing environment and provides the autonomous software agent system 100 with programmatic access to web content, application interfaces, documentation repositories, APIs, development resources, and other remote computing services. A browser tool 410 may implement one or more communication protocols, including HTTP, HTTPS, WebSocket, or other network transport protocols.

In the context of the autonomous software agent system 100, a browser tool 410 may be configured to retrieve web pages, API responses, source code repositories, software documentation, or structured data from remote systems; render and parse markup languages including HTML, XML, Markdown, and script-generated content; execute client-side scripts in a sandboxed runtime; extract structured representations of document object models (DOMs), metadata, form fields, and interactive elements; submit forms, authenticate sessions, manage cookies or tokens, and maintain session state; download, upload, or modify remote resources under controlled permissions; provide machine-readable representations of rendered content to the autonomous software agent system 100 for reasoning and code generation; and enforce network policies, domain restrictions, rate limits, and security guardrails.

In some embodiments, a browser tool 410 is configured to expose structured outputs—such as DOM trees, accessibility trees, rendered text, event traces, console logs, or network traces—rather than or in addition to graphical output. A browser tool 410 may operate in headless mode and may be programmatically controlled via an automation interface.

A browser tool 410, as part of the independent virtual machine computing environment, is isolated from a host computing system and subject to resource constraints, execution monitoring, and security policies defined by the independent virtual machine computing environment. This isolation permits the autonomous software agent system 100 to perform research, dependency resolution, API inspection, automated testing of web applications, or code retrieval without exposing the host environment to uncontrolled network interactions. Unless expressly limited, a browser tool 410 encompasses any web client, headless browsing engine, embedded rendering engine, automated browsing framework, or network-interaction module configured to retrieve and interact with remote content within a virtualized execution environment controlled by the autonomous software agent system 100.

In some embodiments, the integrated development environment (IDE) 412 refers to an editor tool to write computer code and computer tests. In some embodiments, the integrated development environment 412 is a software application that brings together software tools for software development. In particular, the integrated development environment 412 refers to a software application that combines essential software development features (e.g., coding, debugging, testing, and deployment) to increase the efficiency of completing software projects. The IDE 412 may further maintain structured representations of a project state, including file hierarchies, dependency graphs, abstract syntax trees (ASTs), symbol tables, error diagnostics, execution traces, and build artifacts. In the context of the autonomous software agent system 100, the IDE 412 is configured to one or more software tasks; create, edit, refactor, or delete source files; invoke compilation or interpretation processes; execute unit tests or integration tests; surface compiler diagnostics and runtime errors; perform automated refactoring or formatting; manage branches and commits within a version control system; and return structured, machine-readable feedback to the autonomous software agent system 100 to enable iterative reasoning and code refinement.

In some embodiments, the integrated development environment 412 is a fully featured application that allows an autonomous software agent to write, test, and debug code without switching between different software applications. For example, the integrated development environment can include a code editor (e.g., syntax highlighting, code completion, etc.), a compiler/interpreter (e.g., converts source code into executable program code), a debugger (e.g., to find and fix computer code errors), a file browser (e.g., to navigate through files in a centralized development platform), version control (e.g., commit, push, pull, merge computer code in a code repository), and a terminal (e.g., direct command execution to run scripts or access computer system utilities).

In some embodiments, the autonomous software agent system 100 provides a code editor to the autonomous software agent, where the code editor is a sub-component of the integrated development environment. In other words, in some embodiments, the autonomous software agent system 100 provides a fully featured IDE that merges the functionalities of a code editor and the shell tool 408.

Accordingly, the autonomous software agent system 100 provides the autonomous software agent with its own IDE (e.g., independent of a computer code development environment of a user computing device that submitted the prompt 402) to perform software coding tasks. In other words, the autonomous software agent has full access to the integrated development environment 412, which enables the autonomous software agent to complete complex software development tasks.

In one or more embodiments, the planner tool 414 refers to an artificial intelligence model that analyzes a prompt 402 and plans how to execute one or more corresponding software tasks. In particular, the planner tool 414 breaks down a software task to manageable tasks and generates an artificial intelligence plan. In some embodiments, the autonomous software agent system 100 utilizes the planner tool 414 to generate the artificial intelligence plan and presents the artificial intelligence plan to a user computing device to modify or confirm one or more aspects in the artificial intelligence plan.

More specifically, that planner tool is configured to analyze one or more input objectives, user intents, or software task specifications and to generate structured, multi-step plans that guide operation of an autonomous software agent system 100 in performing code generation, modification, testing, analysis, or orchestration tasks. The planner tool 414 may be implemented using one or more underlying computational models, including but not limited to large language models (LLMs), transformer-based neural networks, sequence-to-sequence models, reinforcement learning models, probabilistic graphical models, symbolic reasoning engines, constraint solvers, heuristic search algorithms, or hybrid neuro-symbolic architectures. In one or more embodiments, planner tool 414 leverages a generative pretrained transformer model, including a code-capable language model, to infer task structure, identify implicit constraints, and predict ordered action sequences based on prior training across natural language corpora, source code repositories, execution traces, and software development workflows.

In one or more embodiments, the planner tool 414 is configured to decompose complex objectives into a sequence of actionable subtasks, determine dependencies and ordering among subtasks, and construct an execution plan consumable by downstream components such as code generation modules, debugging modules, the browser tool 410, the shell tool 408, IDE 412, testing frameworks, or other tool interfaces. The generated plan may comprise, without limitation, a hierarchical task tree, directed acyclic graph (DAG), ordered action list, state machine representation, or other structured plan representation including defined inputs, outputs, preconditions, postconditions, and success criteria.

In certain embodiments, planner tool 414 employs prompt-based reasoning, chain-of-thought inference, tree search, beam search, Monte Carlo sampling, reinforcement learning-based policy selection, or combinations thereof to evaluate multiple candidate plans and select or refine a plan according to defined optimization metrics. The planner tool 414 may further incorporate memory mechanisms, including contextual embeddings, vector databases, episodic execution logs, or persistent state representations, to inform plan generation based on prior interactions or historical outcomes. The planner tool 414 may monitor intermediate execution results and dynamically revise, re-order, expand, or prune subtasks based on feedback including compiler diagnostics, runtime errors, test failures, environmental changes, or external tool responses. In this manner, planner tool 414 supports iterative, adaptive, reactive, or predictive planning strategies. In some embodiments, the planner tool 414 operates as a distinct module that communicates with other components of autonomous software agent system 100 via structured messages, application programming interfaces (APIs), or message-passing protocols.

In one or more embodiments, the autonomous software agent system 100 utilizes the planner tool 414 to generate an artificial intelligence plan in accordance with one or more embodiments. In particular, the autonomous software agent system 100 accesses/receives the prompt 402 (e.g., from a user of a computing device). Furthermore, the autonomous software agent system 100 deploys an autonomous software agent to operate within an independent virtual machine computing environment.

In one or more embodiments, the autonomous software agent system 100 utilizes the planner tool 414 to improve the efficiency and accuracy of executing a software task from the prompt 402. In some embodiments, the autonomous software agent system 100 utilizes the planner tool 414 to generate a running “to do” list. In particular, the autonomous software agent system 100 can use the planner tool 414 to break down the prompt 402 and to infer one or more intents of the prompt 402. In one or more embodiments, the autonomous software agent system 100 utilizes the planner tool 414 to assist a user in visualizing how the autonomous software agent (e.g., deployed by the autonomous software agent system 100) plans and thinks through solving a problem (e.g., as indicated in the prompt 402).

In some embodiments, the autonomous software agent system 100 utilizes a large language model (e.g., a planning model) to analyze the prompt. In one or more embodiments, the autonomous software agent system 100 utilizes the large language model that leverages retrieval-augmented generation (RAG) to generate an artificial intelligence plan. In some embodiments, retrieval-augmented generation refers to retrieving relevant information from an external database or knowledge source in the context of the prompt 402. In particular, the autonomous software agent system 100 can utilize RAG (e.g., which includes using the large language model) to generate a response (e.g., the artificial intelligence plan) by leveraging both the retrieved information (from an external source) and its own internal knowledge base. In particular, the autonomous software agent system 100 leverages RAG, which includes an input query, information retrieval, and response generation to perform a task of generating the artificial intelligence plan.

In some embodiments, the autonomous software agent system 100 further utilizes the large language model to perform an act of extracting a meta-task from the prompt 402. Moreover, as shown, the autonomous software agent system 100 performs an act of extracting intermediate tasks (e.g., sub-tasks) from the meta-task. In one or more embodiments, the autonomous software agent system 100 analyzes the prompt 402, determines an intent (e.g., a meta-task) of the prompt 402, and determines discrete sub-tasks (e.g., intermediate tasks).

In particular, the autonomous software agent system 100 can prompt the large language model to divide the prompt 402 into manageable and discrete sub-portions. In other words, the autonomous software agent system 100 prompts the large language model to identify tasks that point to different code repositories, data sources, and systems as being their own sub-task. In particular, the autonomous software agent system 100 can prompt the large language model and include example breakdowns of example requests.

Moreover, in some embodiments, the autonomous software agent system 100 trains the large language model with example datasets for breaking down a request into a meta-task and a plurality of sub-tasks. In particular, the autonomous software agent system 100 trains the large language model by having it generate a predicted artificial intelligence plan and then comparing the prediction to a ground truth reference.

In some embodiments, the autonomous software agent system 100 utilizes the large language model to generate an artificial intelligence plan to execute a software task. In particular, the autonomous software agent system 100 generates the artificial intelligence plan which includes a meta-task extracted from the prompt 402 and intermediate tasks extracted from the meta-task. In one or more embodiments, the autonomous software agent system 100 provides the artificial intelligence plan to a graphical user interface of a computing device. In particular, the autonomous software agent system 100 provides the artificial intelligence plan to receive approval or modification from a user computing device.

In one or more embodiments, the autonomous software agent system 100 can determine one or more code repositories that are connected via a code repository management system based on the artificial intelligence plan (e.g., generated by the planner tool 414). As discussed above in FIGS. 1-3, the autonomous software agent system 100 improves the accuracy and efficiency of executing a software task by accessing relevant code repositories. In particular, the autonomous software agent system 100 deploys an autonomous software agent to access code repositories required to execute a software task.

To illustrate, the autonomous software agent system 100 can generate an artificial intelligence plan that indicates that a first sub-task corresponds to first code documentation within a code repository management system, a second sub-task corresponds to a first code repository within the code repository management system, a third sub-task corresponds to second code documentation within the code repository management system, and a fourth sub-task corresponds to generating a pull request. In some embodiments, the autonomous software agent system 100 determines that the autonomous software agent does not have writing access, thus the autonomous software agent cannot generate a pull request indicated by the artificial intelligence plan. As such, the autonomous software agent system 100 can request/prompt a user computing device to provide the necessary access rights to complete the fourth sub-task.

In some embodiments, the autonomous software agent system 100 can receive modifications to one or more tasks/sub-tasks and/or the meta-task extracted from the prompt 402. In some instances, the autonomous software agent system 100 can receive additional context or additional files to further customize the artificial intelligence plan. In some embodiments, the autonomous software agent system 100 receives one or more modifications to the artificial intelligence plan and generates a modified artificial intelligence plan.

Further, the autonomous software agent system 100 can prompt a user of a computing device to provide approval of the modified artificial intelligence plan. In response to receiving approval of an (updated) artificial intelligence plan, the autonomous software agent system 100 deploys the autonomous software agent to execute the prompt 402 according to the artificial intelligence plan.

In some embodiments, the autonomous software agent system 100 utilizes the browser tool 410 to perform one or more actions responsive to prompt 402 to execute a software task. For example, the autonomous software agent system 100 accesses/receives the prompt 402. In one or more embodiments, the autonomous software agent system 100 utilizes the browser tool 410 to browse documentation on one or more website domain pages, test web applications (e.g., local applications), download information, upload information, etc. In particular, the autonomous software agent system 100 utilizes the browser tool 410 to perform a first navigation step, a second navigation step, and a third navigation step on a website domain page.

In one or more embodiments, a website page (e.g., a website domain page) refers to a webpage hosted under a domain name that serves as an entry point of a website and is identified by a URL. For example, a website page refers to a digital webpage associated with a domain name that has a unique URL and contains structured content (e.g., text, images, links, and other media). In particular, a website page is part of a larger website hierarchy. To illustrate, a website hierarchy includes a homepage, subpages, and subdomain pages. In some embodiments, a plurality of website pages is associated with an entity.

In one or more embodiments, the autonomous software agent system 100 utilizes the browser tool 410 to obtain information from a website page. In some embodiments, the autonomous software agent system 100 determines whether a particular portion of a website page is relevant to the prompt 402 to execute a software task. In particular, the autonomous software agent system 100 utilizes a large language model (e.g., a website relevance model) to determine the relevance of a sub-portion, portion, or entire website page.

In other words, website pages contain an excessive amount of information. In particular, large language models are typically bogged down with processing all elements within a website page. Thus, the autonomous software agent system 100 distills a website page structure (e.g., utilizing the large language model) and provides a simplified structure (e.g., HTML) to the autonomous software agent for further processing. In doing so, the autonomous software agent system 100 enables the autonomous software agent to process a large amount of data from website pages without performance degradation.

In some embodiments, the autonomous software agent system 100 utilizes the large language model to perform an act of determining a document object model (DOM) of a website page. In particular, the autonomous software agent system 100 passes a website page to the large language model to determine a document object model of the website page.

In one or more embodiments, a document object model refers to a structured, hierarchical representation of a webpage's content that defines how HTML elements are programmatically accessed, modified, and analyzed. In one or more embodiments, the autonomous software agent system 100 detects a document object model object within a website page. For example, the DOM includes a representation of structure, content and properties within a website page. For instance, a user of a website page interacts with and manipulates a DOM object. Further, in some embodiments the DOM includes HTML or XML format. Accordingly, the DOM includes references to specific elements or nodes within the website page. To illustrate, DOM objects are part of a DOM tree structure, where each node of the DOM tree structure corresponds to a specific element in a website page.

In some embodiments, the autonomous software agent system 100 utilizes the large language model to perform an act of identifying relevant document object model elements (e.g., DOM elements). In particular, the autonomous software agent system 100 prompts the large language model to identify relevant DOM elements in the context of the prompt 402. In other words, the autonomous software agent system 100 utilizes the large language model to distill a website domain page into a relevant set of elements for the prompt 402.

In some embodiments, the autonomous software agent system 100 utilizes the large language model to generate a simplified DOM tree (e.g., a simplified document object model tree). As mentioned above, in some instances, a website page contains a large amount of data that can potentially bog down computational processes. As such, the autonomous software agent system 100 utilizes the large language model to extract the most salient/relevant elements from a website page (e.g., being browsed via the browser tool 410) and generates the simplified DOM tree.

In one or more embodiments, the simplified DOM tree refers to a distilled document object model structure and/or a distilled hierarchical representation of a webpage's content. In particular, the simplified DOM tree includes a hierarchy of nodes and elements from the website page that are relevant to the prompt 402. In other words, the simplified DOM tree contains fewer website page elements relative to an initially determined DOM tree from the website page.

In one or more embodiments, the autonomous software agent system 100 utilizes an autonomous software agent to perform a software task of testing a local application. Moreover, in some embodiments, the autonomous software agent system 100 determines that access to a specific subset of code repositories (e.g., of a code repository management system) is required to test the local application. As such, the autonomous software agent system 100 can utilize the autonomous software agent to access the specific subset of code repositories (e.g., that contain computer software quality tests) and test the local application utilizing the browser tool 410.

In some embodiments, the autonomous software agent system 100 utilizes the shell tool 408 to generate one or more terminal commands. In one or more embodiments, the shell tool 408 refers to one or more terminals (e.g., one or more terminal windows). In particular, the autonomous software agent system 100 deploys the autonomous software agent that can create new terminal windows or switch to different terminal windows, or delete terminals (e.g., which is how an autonomous software agent can run multiple processes at once). For relatively long commands, the autonomous software agent system 100 can use the autonomous software agent to shift its attention away from the long-running command and multitask in parallel (e.g., via the shell tool 408).

In some embodiments, the shell tool 408 is a text-based application where the autonomous software agent can input commands that interact directly with a computer's operating system. In particular, the autonomous software agent system 100 spins up the autonomous software agent that includes a shell application and in the shell application there are different terminals. As mentioned, where each terminal is like a single terminal window, the autonomous software agent system 100 (e.g., via the autonomous software agent) has the ability to create new terminals, switch to different terminal windows or delete terminals.

Furthermore, the autonomous software agent system 100 performs an act of utilizing the autonomous software agent to generate terminal commands. In one or more embodiments, a terminal command refers to text instructions to instruct a computer's operating system. In particular, a terminal command refers to one-line instructions that typically call upon existing programs of an operating system.

In some embodiments, a terminal command refers to text-based instructions submitted/inputted into a terminal (e.g., the terminal is an interface that allows computing devices such as the autonomous software agent to interact with a computer system's underlying operating system or run scripts and programs directly). To illustrate, terminal commands can include file and directory navigation, file operations, viewing file contents, searching and filtering, processes and systems in an operating system, determining permissions and ownerships in an operating system, and networking.

Moreover, the autonomous software agent system 100 generates command outputs. In one or more embodiments, command outputs refer to outputs that correspond with terminal commands submitted via the shell tool 408. To illustrate, a command output can include an absolute path (e.g., in response to a command to determine a location), tabular text (e.g., in response to a command to list files), raw file text (e.g., in response to a command to print file contents), an interactive viewer (e.g., in response to a command to provide a paged output), an output pattern (e.g., in response to a command to search/filter files in an operating system), and a file path (e.g., in response to a command to locate files).

Accordingly, the autonomous software agent system 100 utilizes the autonomous software agent to execute a software task (e.g., indicated by the prompt 402) by using the shell tool 408. In particular, the autonomous software agent system 100 determines a plurality of sub-tasks for a meta-task indicated in the prompt 402, generates an artificial intelligence plan, and utilizes the shell tool 408 to execute one or more of the sub-tasks (e.g., by submitting terminal commands).

In some embodiments, the autonomous software agent system 100 receives a selection of a shell feature and opens/launches an interactive shell of the autonomous software agent. In particular, the autonomous software agent system 100 causes a graphical user interface (e.g., of a user computing device) to show shell activity (e.g., terminal commands or outputs corresponding to terminal commands) of the autonomous software agent utilizing the shell tool 408 while independently performing the software task. Accordingly, the user computing device (e.g., via the graphical user interface) can intervene (e.g., take over) the autonomous software agent's shell and push a software task in a different direction.

In one or more embodiments, the autonomous software agent system 100 utilizes an integrated development environment to generate computer code in accordance with one or more embodiments. For example, the autonomous software agent system 100 accesses/receives a request and deploys an autonomous software agent. In particular, the autonomous software agent system 100 deploys the autonomous software agent to operate within an independent virtual machine computing environment.

Moreover, the autonomous software agent system 100 provides the integrated development environment 412 (IDE tool) to the autonomous software agent. In one or more embodiments, the integrated development environment 412 of the autonomous software agent includes an editor (e.g., in some embodiments, the autonomous software agent utilizes multiple editor tabs which represent open files in an editor area of the IDE for writing/editing computer code). In particular, the editor corresponds to an open file.

As mentioned above, the autonomous software agent has access to its own editor. In some embodiments, an editor refers to a software program or tool for writing or modifying computer code. In particular, an editor streamlines a computer code writing process by providing syntax highlighting, auto-completion, and error detection. For example, the editor provides color-coding for keywords, variables, functions, and other code elements. Further, for auto-completion, the editor suggests completions for variables, methods, classes, and functions.

In some embodiments, project files refer to a set of files and resources organized together to represent a specific software coding task (e.g., project). For example, the project files can include source code (e.g., program code written in a specific programming language), configurations (e.g., settings defining how a project is built, compiled, and executed), dependencies (e.g., external libraries), libraries, assets, and other components required to complete a software coding task.

In some embodiments, the autonomous software agent system 100 utilizes the integrated development environment 412 to perform an act of generating computer code. In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. In some embodiments, function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

In some embodiments, test code refers to computer code that defines a function test for function code. For example, test code can include one or more code segments for determining that the function code satisfies an intent query. In some cases, the autonomous software agent system 100 utilizes test code to test function code. For example, the autonomous software agent system 100 generates the test code that includes computer code for testing whether the output of function code satisfies an intent query. In some embodiments, test code can also test for different types of errors (e.g., syntax errors and logic errors) and/or for hazardous or harmful function code.

In some embodiments, the computer code includes executable program code which refers to a set of instructions that a computing device can directly execute. In particular, executable program code includes machine-readable instructions that result from compiling high-level programming languages. In other words, executable program code refers to a final output for a software development process created by compiling source code.

As noted above, in one or more embodiments, the autonomous software agent system 100 provides actions performed by the autonomous software agent to a graphical user interface of a user (e.g., a user computing device). In particular, in context of the integrated development environment 412, the autonomous software agent system 100 can provide to a graphical user interface real-time actions and/or actions performed during a development session of the autonomous software agent utilizing the integrated development environment 412.

In some embodiments, the autonomous software agent system 100 can receive an input selection that relates to a user computing device indicating a desire to modify one or more inputs in the integrated development environment 412. Further, in some embodiments, the autonomous software agent system 100 can receive an input selection to follow the autonomous software agent (e.g., in real-time) as the autonomous software agent executes a software task indicated by the prompt 402.

In some embodiments, the autonomous software agent system 100 provides for display the integrated development environment 412 that includes the above-mentioned editor tab. Further, in some instances, the autonomous software agent system 100 also provides a problems tab which lists errors, warnings, and information for computer code (in the editor tab) for a user to efficiently see errors in computer code or jump to problematic portions of computer code), an output tab (e.g., shows logs and messages from the IDE or extensions of the IDE to be notified of background activities like loading data onto a server or plugin operations), a debug console (e.g., allows for interactions with a program during debugging, such as viewing runtime logs, evaluating expressions, or inspecting variables), a terminal (e.g., a built-in shell/command-line interface for executing/submitting commands to a terminal, such as running scripts or installing packages), and a version control tab (e.g., provides information as to which devices submitted changes to a code repository and why the changes were submitted to a code repository).

In one or more embodiments, the autonomous software agent system 100 detects additional required permissions as the autonomous software agent is utilizing the integrated development environment 412. In particular, the autonomous software agent system 100 prompts a user computing device to grant additional access permissions in response to detecting the additional required permissions for executing a software task.

Additionally, FIG. 4 shows the autonomous software agent system 100 generating artificial intelligence output(s) 416 as part of deploying the autonomous software agent by accessing one or more of the aforementioned software composition tools (e.g., the shell tool 408, the browser tool 410, the integrated development environment 412, and/or the planner tool 414).

More specifically, in one or more embodiments, the autonomous software agent system 100 is configured to automatically (e.g., without further user instructions other than the prompt defining the software task) perform an assigned software task using coordinated interaction among planner tool 414, browser tool 410, an integrated development environment (IDE) 412, a shell tool 408, and an independent virtual machine computing environment. For example, upon receiving a software task—expressed in natural language, structured specification, source code fragment, test case, or other machine-interpretable format—the autonomous software agent system 100 provides the software task to planner tool 414. The planner tool 414 analyzes the objective and generates a structured execution plan comprising an ordered set of subtasks, dependency relationships, required tools, expected outputs, and validation criteria. The execution plan may define actions such as retrieving documentation, generating source code, creating files, compiling code, executing tests, debugging failures, refactoring modules, or deploying artifacts. The autonomous software agent system 100 executes the structured plan within the independent virtual machine computing environment. Where plan steps require external information or dependency retrieval, the autonomous software agent system 100 invokes the browser tool 410 within the independent virtual machine computing environment. The autonomous software agent system 100 uses the browser tool 410 to retrieve and parse remote documentation, API specifications, repositories, or other network-accessible resources and returns structured, machine-readable representations to autonomous software agent system 100 for reasoning and code synthesis.

For code authoring and modification operations, the autonomous software agent system 100 interacts with the IDE 412. The IDE 412 enables creation, editing, refactoring, and organization of source files, as well as invocation of compilers, interpreters, build systems, static analysis tools, and test frameworks. The IDE 412 provides structured diagnostics, including syntax errors, semantic warnings, dependency conflicts, and build logs, which are returned to autonomous software agent system 100. Where system-level commands are required, autonomous software agent system 100 issues instructions through the shell tool 408 executing within the independent virtual machine computing environment. The shell tool 408 enables file system manipulation, dependency installation, build execution, test invocation, process control, and other operating system-level operations. Structured outputs including exit codes, logs, and error streams are returned to autonomous software agent system 100.

The planner tool 414, in one or more implementations, monitors intermediate results generated by the IDE 412, browser tool 410, and shell tool 408, and compares those results against plan-defined success criteria. If discrepancies, failures, or unexpected states are detected, the planner tool 414 automatically revises the execution plan, generates corrective subtasks, reorders actions, or initiates debugging procedures. This iterative loop continues until the software task satisfies defined completion conditions or termination criteria. In this manner, autonomous software agent system 100 autonomously decomposes, executes, validates, and refines development actions within the independent virtual machine computing environment using coordinated tool invocation and structured feedback processing. The integration of planner tool 414, browser tool 410, the 412, the shell tool 408, and the independent virtual machine computing environment enables end-to-end automated software development, testing, and validation without direct human intervention.

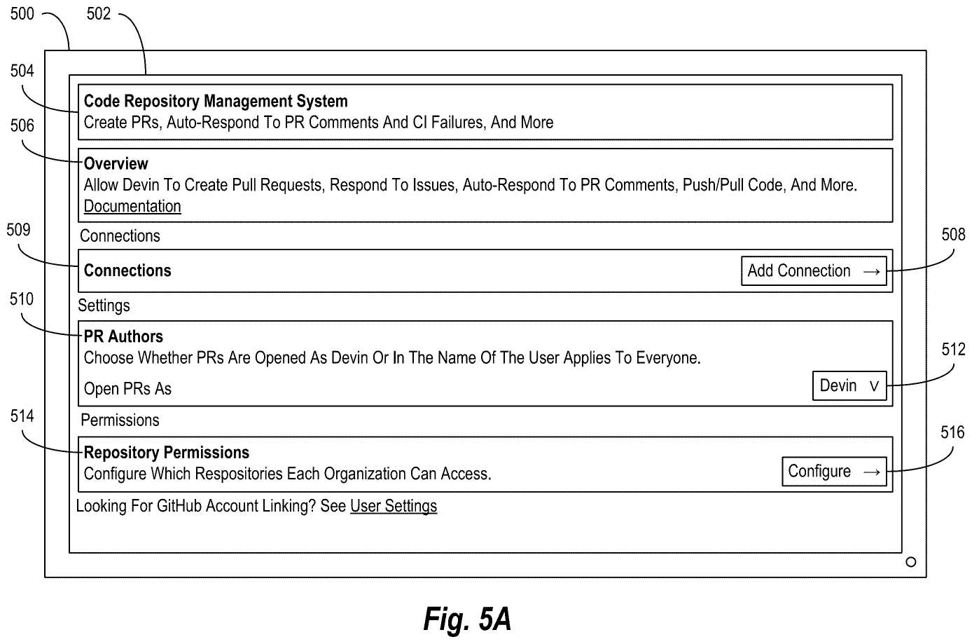

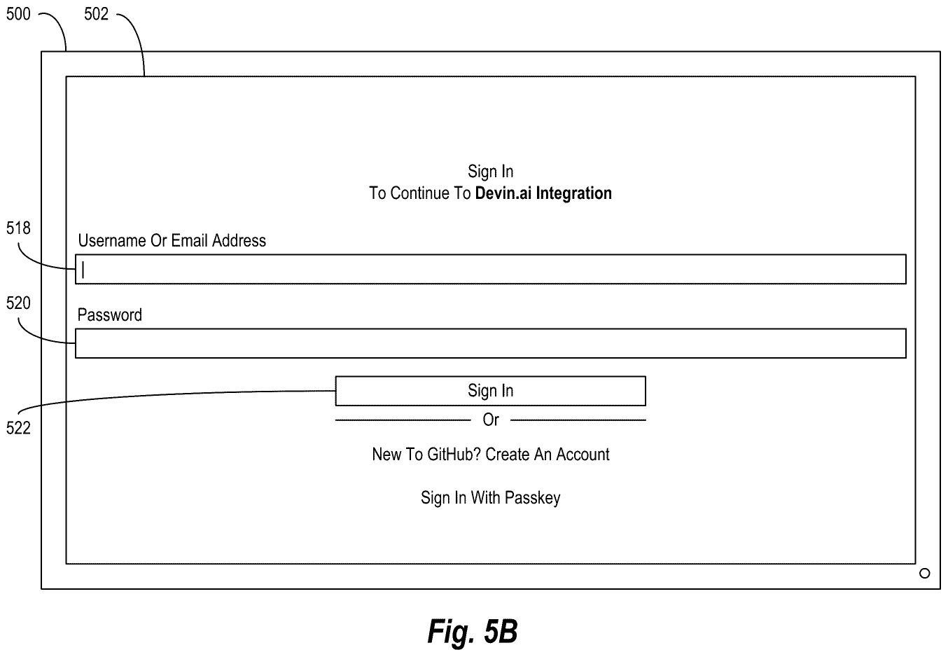

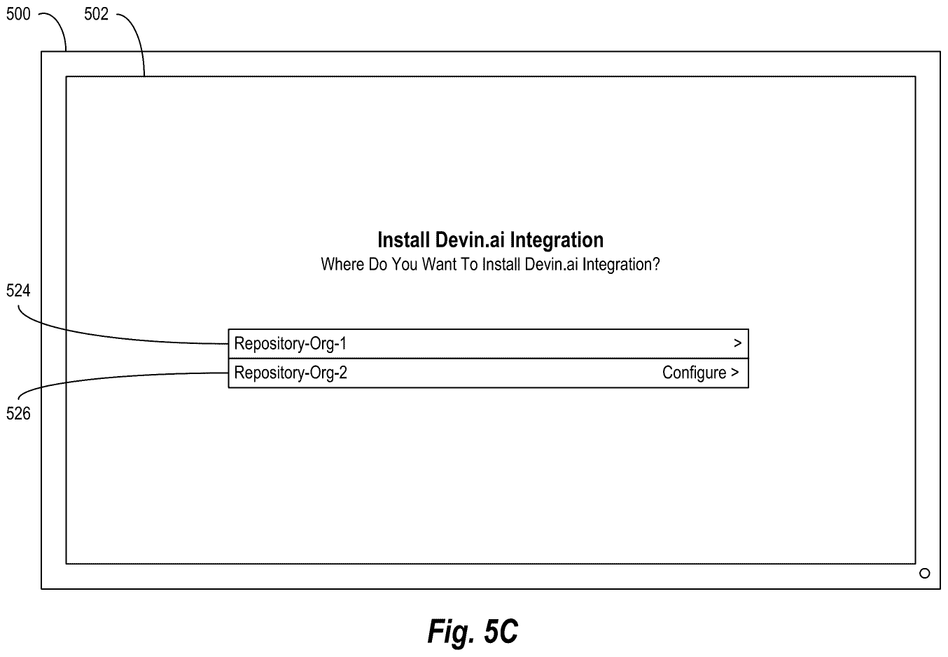

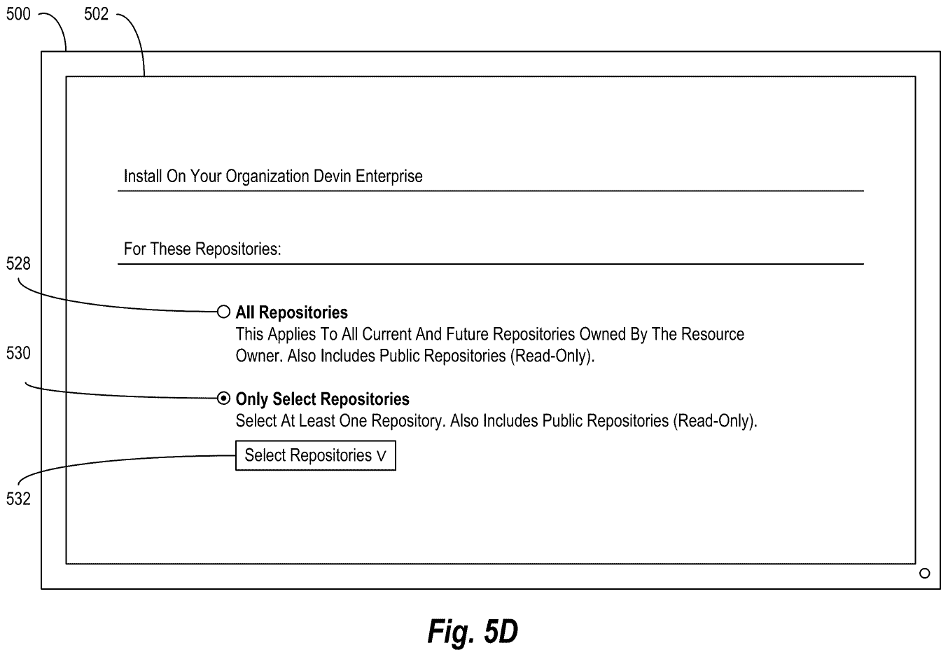

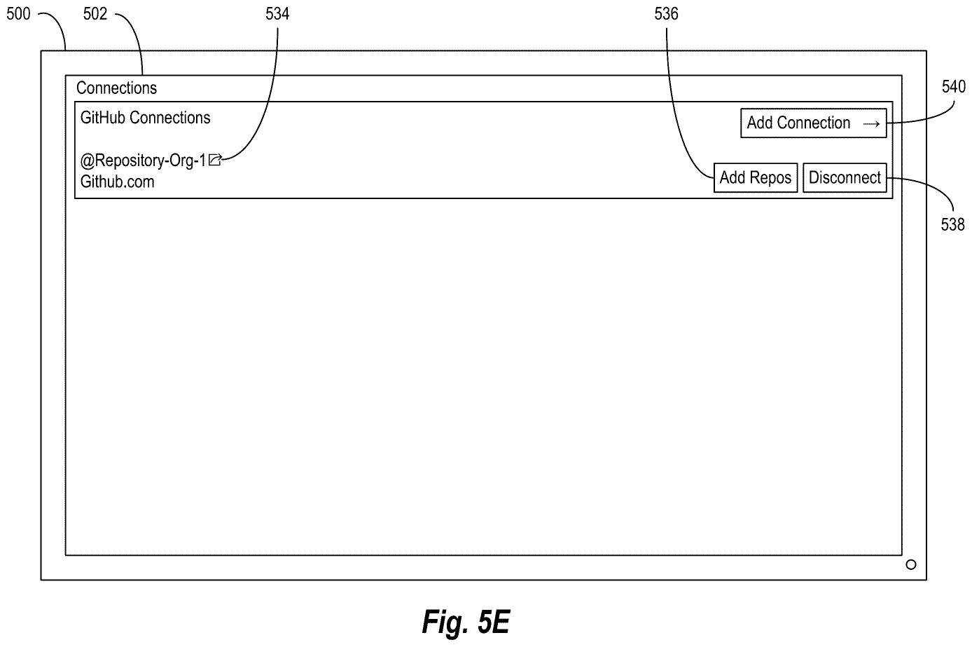

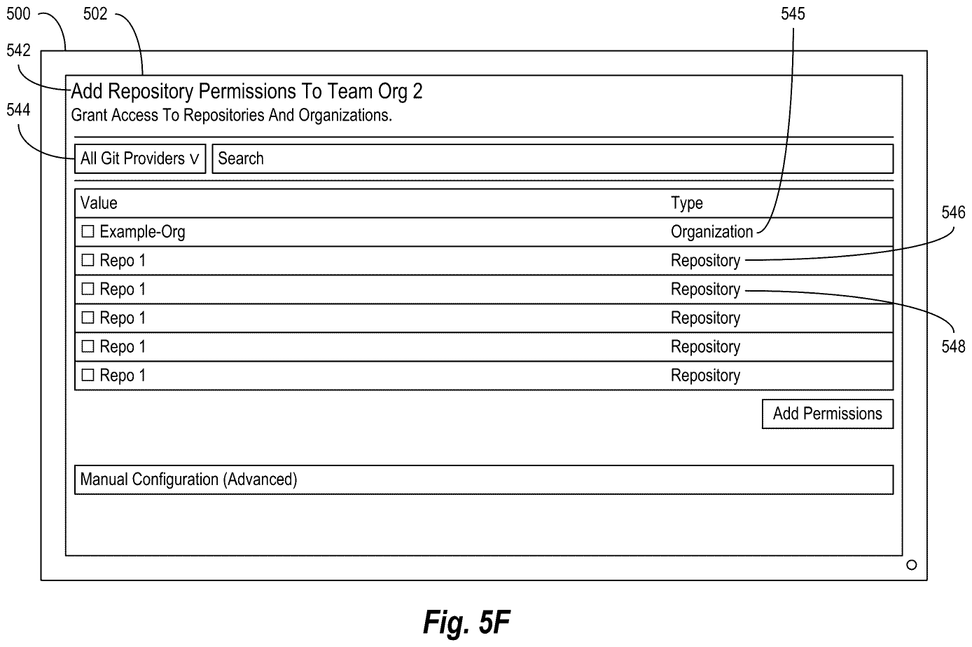

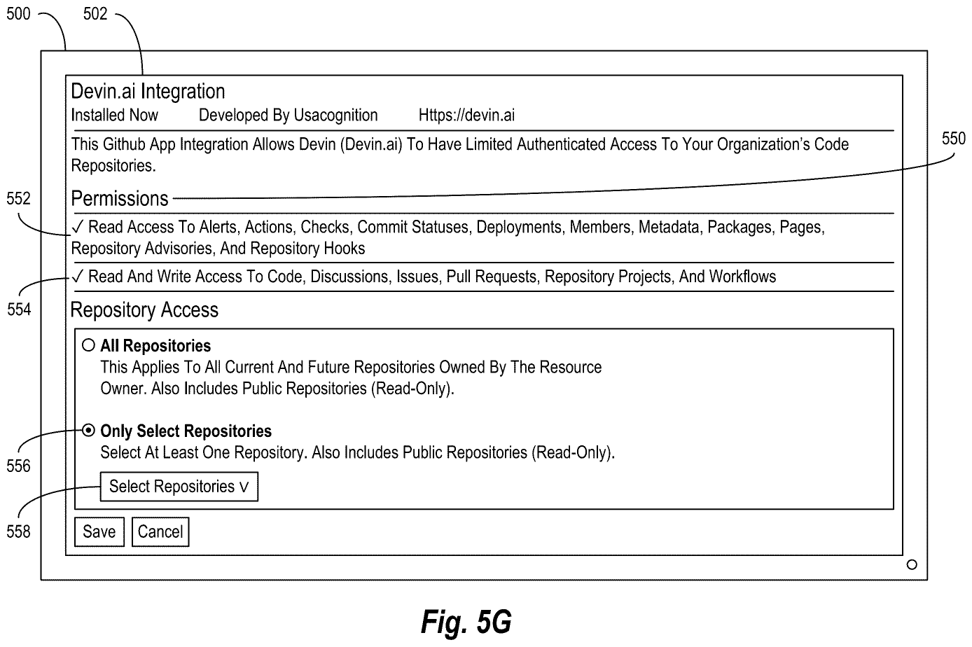

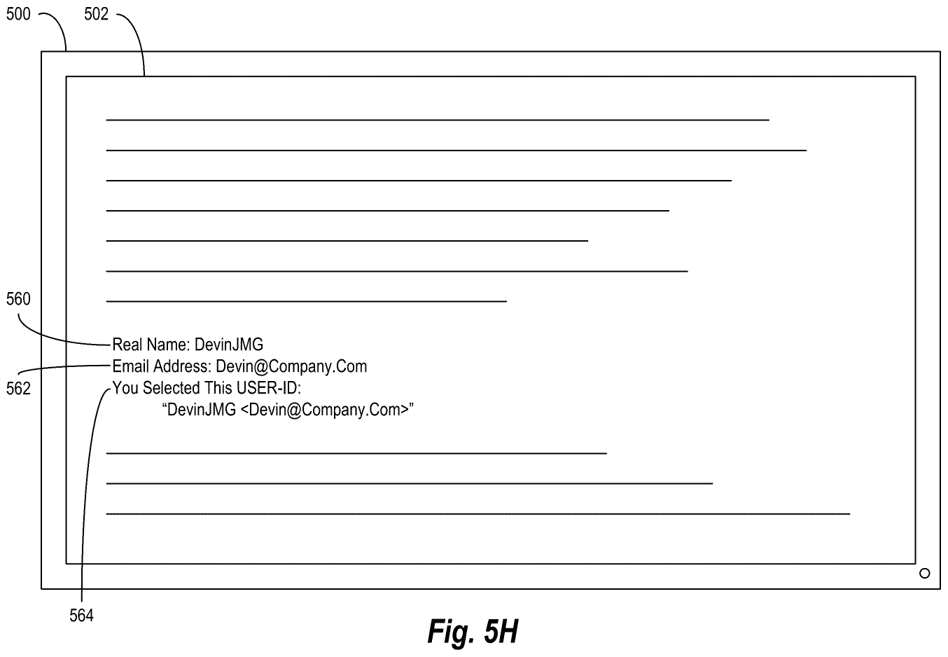

FIG. 5A shows the autonomous software agent system 100 providing a code repository connection interface in accordance with one or more embodiments. For example, FIG. 5A shows a graphical user interface 502 of a user computing device 500 displaying a code repository connection interface for configuring an autonomous software agent to access one or more code repositories. As mentioned above, the autonomous software agent system 100 causes an autonomous software agent to access connected code repositories while executing a software task.

FIG. 5A shows a first section 504 that includes guidance instructions for connecting with a code repository management system. In particular, the first section 504 indicates that an autonomous software agent can be granted permissions to create pull requests, auto-respond to pull request comments, code integration failures, and more. Moreover, FIG. 5A shows a second section 506 that includes an overview. In particular, the overview indicates that an autonomous software agent can create pull requests, respond to issues, auto-respond to pull request comments, push/pull code, and more.

Additionally, FIG. 5A shows a third section 509 relating to connections. In particular, FIG. 5A shows an add connection element 508. In response to a selection of the add connection element 508, the autonomous software agent system 100 causes the graphical user interface 502 to transition to a screen to configure the connection with the autonomous software agent system 100 and the code repository management system.

Furthermore, FIG. 5A shows a fourth section 510 relating to pull request author. In particular, the fourth section 510 indicates that a user computing device can choose whether pull requests are opened as the autonomous software agent system 100 (e.g., an autonomous software agent deployed by the autonomous software agent system 100) or in the name of another user. Moreover, FIG. 5A shows a pull request author element 512. In response to a selection of the pull request author element 512, the autonomous software agent system 100 provides a drop-down list that shows a variety of options to select as the pull request author.

Additionally, FIG. 5A shows a fifth section 514 that relates to repository permissions. For example, the fifth section 514 indicates that the user computing device 500 can configure which repositories each organization can access. Further, FIG. 5A shows a repository permission configuration element 516. In response to a selection of the repository permission configuration element 516, the autonomous software agent system 100 can receive selections of specific sets of code repositories assigned to specific organizations.

FIG. 5B shows the autonomous software agent system 100 providing a sign-in interface in accordance with one or more embodiments. For example, FIG. 5B shows the autonomous software agent system 100 prompting the user computing device 500 to sign-in to a code repository management system in order to give access to one or more code repositories to the autonomous software agent system 100. In particular, FIG. 5B shows a username or email input element 518 (e.g., corresponding to a target code repository management system). Moreover, FIG. 5B shows a password input element 520 and a sign-in element 522. In response to the user computing device 500 entering the relevant details, the autonomous software agent system 100 can begin a connection with a target code repository management system.

Furthermore, FIG. 5C shows that in response to the user computing device 500 providing details for a target code repository management system, the autonomous software agent system 100 further prompts the user computing device 500 for additional details. For example, FIG. 5C shows the autonomous software agent system 100 prompting the user computing device 500 to provide integration details for installing an integration between the autonomous software agent system 100 and a target code repository management system for a specific organization. In particular, FIG. 5C shows a first organization element 524 and a second organization element 526. For example, a selection of the first organization element 524 would install the integration for a target code repository management system such that only devices part of the first organization would be able to access the target code repository management system.

FIG. 5D shows the autonomous software agent system 100 prompting the user computing device 500 for code repository access. For example, FIG. 5D shows a first element 528 and a second element 530. In particular, the first element 528 provides the autonomous software agent system 100 with access to all code repositories within a connected target code repository management system. For instance, a selection of the first element 528 provides access to all current repositories, future repositories, and public repositories in a target code repository management system.

Moreover, the second element 530 provides access to select repositories within a connected target code repository management system. For instance, a selection of the second element 530 provides access to at least one repository and/or public repositories in the target code repository management system. In particular, FIG. 5D shows a drop-down element 532 that allows the user computing device 500 to select one or more code repositories that are part of the target code repository management system.

FIG. 5E shows the autonomous software agent system 100 providing for display in the graphical user interface 502, already-established connections for code repository management systems. For example, FIG. 5E shows a first connection 534 with a target code repository management system. Additionally, FIG. 5E shows an add repository element 536 to add repository access to the autonomous software agent system 100 for the already-connected code repository management system.

Moreover, FIG. 5E shows a disconnect element 538. In response to a selection of the disconnect element 538, the autonomous software agent system 100 removes the target code repository management system such that the autonomous software agent system 100 cannot access the target code repository management system. Furthermore, FIG. 5E shows an add connection element 540. In response to a selection of the add connection element 540, the autonomous software agent system 100 prompts the user computing device 500 to provide additional connections with additional target code repository management systems.

FIG. 5F shows the autonomous software agent system 100 providing an add repository permissions interface 542 for a specific organization. In particular, in some embodiments, the user computing device 500 is part of a larger entity that contains a plurality of organizations. FIG. 5F illustrates the autonomous software agent system 100 providing the ability to grant code repository management system access to different organizations within the larger entity.

FIG. 5F shows the autonomous software agent system 100 providing for display a filter option 544. In particular, a selection of the filter option 544 allows the user computing device 500 to view permissions by specific code repository management systems. Moreover, FIG. 5F shows a first organization 545, a first code repository access 546, and a second code repository access 548. In other words, FIG. 5F illustrates that the autonomous software agent system 100 for the first organization 545 has access to a first code repository and a second code repository.

In one or more embodiments, the autonomous software agent system 100 provides for display in the graphical user interface 502, an option to delegate the one or more code repositories of one or more computer code repository management systems to one or more pre-defined organization groups (e.g., a marketing group, an engineering group, an executive group, a sales group, etc.). To illustrate, the autonomous software agent system 100 can receive via the graphical user interface, a delegation of a first code repository to a first pre-defined organization group. Additionally, the autonomous software agent system 100 can receive via the graphical user interface, an additional delegation of a second code repository to a second pre-defined organization group.

As shown in FIG. 5G, the autonomous software agent system 100 can further prompt the user computing device 500 for different levels of permission. For example, FIG. 5G shows a permissions heading 550 that shows a first configuration element 552 and a second configuration element 554. In particular, the first configuration element 552 indicates that the autonomous software agent system 100 has read access to alerts, actions, checks, commit statuses, deployments, members, metadata, packages, pages, repository advisories, and repository hooks.

In one or more embodiments, the computer code repository management system 104 transmits webhook events to an endpoint exposed by the autonomous software agent system 100. The webhook events may correspond to repository events including push events, pull request events, issue comment events, check run events, and workflow execution events. Upon receipt of a webhook payload, the autonomous software agent system 100 verifies authenticity of the payload using a cryptographic signature included in the request header. For example, the autonomous software agent system 100 may compute a hash-based message authentication code (HMAC) using a shared secret and compare the computed signature to a received signature value. The autonomous software agent system 100 may further validate event identifiers to prevent replay or duplicate processing. Upon successful verification, the autonomous software agent system 100 routes the event to a tenant-specific execution environment corresponding to the repository installation identifier.

Further, the second configuration element 554 indicates that the autonomous software agent system 100 has read and write access to code, discussions, issues, pull requests, repository projects, and workflows. Additionally, FIG. 5G shows the user computing device 500 selecting a code repository access element 556 that grants the autonomous software agent system 100 access to a subset of code repositories. Further, FIG. 5G shows a drop-down element 558 that allows the user computing device 500 to select a specific set of code repositories.

FIG. 5H shows the autonomous software agent system 100 providing an interface to generate a signing key for signing commits. For example, the autonomous software agent system 100 (e.g., during repository setup) can provide the user computing device 500 with access to a terminal of an autonomous software agent. In particular, FIG. 5H shows a first element 560, a second element 562, and a third element 564. For example, the first element 560 relates to a real name (e.g., DevinJMG), the second element 562 relates to an email address (e.g., devin@company.com) and the third element 564 relates to a selected user identifier (e.g., “DevinJMG”). In doing so, the autonomous software agent system 100 receives a dedicated signing key for an autonomous software agent making it easier to identify commits from the autonomous software agent system 100.

In one or more embodiments, the autonomous software agent system 100 provides an interface (e.g., a shell interface) to generate a signing key for an autonomous software agent. In particular, the autonomous software agent system 100 can receive a terminal command to generate a key pair, a size of the key, and a length of time the key should be valid. In doing so, the autonomous software agent system 100 can create a signing key for an autonomous software agent that generates pull requests to post to a connected code repository management system.

In one or more embodiments, the autonomous software agent system 100 defines read access permissions for accessing a connected code repository. The following table illustrates read permissions for an autonomous software agent:

| Permission | Description |
|---|---|
| Dependabot | This allows the |
| alerts | autonomous software agent |
| | system 100 to resolve |
| | dependabot alerts (a |
| | notification that a software |
| | dependency with a |
| | known security |
| | vulnerability is being used) on |
| | a user's behalf (i.e., by |
| | bumping dependency |
| | versions). |
| Actions | This allows the |
| | autonomous software agent |
| | system 100 to view the |
| | actions configured for |
| | a code repository in |
| | order to understand if an |
| | autonomous software |
| | agent has made changes |
| | that pass a continuous |
| | integration (e.g., a |
| | software development |
| | practice to frequently |
| | commit code changes |
| | to a shared repository, |
| | which then triggers |
| | automated builds and |
| | testing to detect |
| | defects earlier). |
| Checks | This allows the |
| | autonomous software agent |
| | system 100 to view the |
| | checks configured for |
| | a code repository in |
| | order to understand if an |
| | autonomous software |
| | agent has made changes |
| | that pass a continuous |
| | integration. |
| Commit | This allows the |
| statuses | autonomous software agent |
| | system 100 to view |
| | if a commit passes a |
| | continuous integration. |
| Deployments | This allows the |
| | autonomous software agent |
| | system 100 to view |
| | which versions of a code |
| | repository were deployed. |
| Metadata | This allows the |
| | autonomous software agent |
| | system 100 to view |
| | crucial metadata about a |
| | repository such as who owns it. |
| Packages | This allows the |
| | autonomous software agent |
| | system 100 to view |
| | which versions of a |
| | repository were |
| | shipped as a package. |
| Pages | This allows the |
| | autonomous software agent |
| | system 100 to consult |
| | pages associated with a |
| | code repository, e.g., |
| | to view documentation. |
| Repository | This allows the |
| advisories | autonomous software agent |
| | system 100 to view |
| | security advisories related |
| | to a code repository |
| | in order to help fix |
| | security issues. |
| Repository | This allows the |
| hooks | autonomous software agent |
| | system 100 to view |
| | hooks configured for a |
| | code repository, e.g., |
| | linting and type |
| | checking. |
| Repository | This allows the |
| projects | autonomous software agent |
| | system 100 to view |
| | projects associated with a |
| | code repository, e.g., |
| | to retrieve information |
| | about a task. |

In one or more embodiments, the autonomous software agent system 100 defines read and write access permissions for making one or more modifications to a connected code repository. The following table illustrates read and write access permissions for an autonomous software agent:

| Permission | Description |
|---|---|
| Code | This allows the |
| | autonomous software agent |
| | system 100 to contribute |
| | to a connected |
| | codebase. |
| Discussions | This allows the |
| | autonomous software agent |
| | system 100 to contribute |
| | to discussions |
| | corresponding to a |
| | code repository |
| | management system. |
| Issues | This allows the |
| | autonomous software agent |
| | system 100 to |
| | open new issues. |
| Pull requests | This allows the |
| | autonomous software agent |
| | system 100 to |
| | create new pull requests. |
| Workflows | This allows the |
| | autonomous software agent |
| | system 100 to set up new o |
| | workflows, e.g., t |
| | help configure CI/CD |
| | (e.g., continuous |
| | integration and continuous |
| | delivery/deployment). |

In one or more embodiments, the autonomous software agent system 100 establishes security parameters for an autonomous software agent with access to a connected code repository management system. For example, the autonomous software agent system 100 provides options to add branch protection rules for main branches of computer code within a code repository management system. In adding branch protection rules, the autonomous software agent system 100 can increase security by requiring checks on autonomous software agent activities before merging changes within a connected code repository.

In one or more embodiments, in response to a repository-triggered task, the autonomous software agent system 100 creates a new branch derived from a base branch of the repository. The branch may follow a naming convention that encodes a task identifier, session identifier, or timestamp. The autonomous software agent system 100 performs code modifications exclusively within the created branch to preserve integrity of protected branches such as a default branch. In some embodiments, the autonomous software agent system 100 detects branch protection rules and ensures that direct commits to protected branches are avoided. If merge conflicts are detected during rebasing or merging, the autonomous software agent system 100 may attempt automated conflict resolution or notify users within a repository interface.

Furthermore, in some embodiments, the autonomous software agent system 100 restricts autonomous software agents to permissions granted at an organizational level. In particular, the autonomous software agent system 100 does not grant permissions to autonomous software agents based on an individual user account that initialized a development session. Moreover, in some embodiments, the autonomous software agent system 100 does not allow an autonomous software agent to create a new repository within a connected code repository management system.

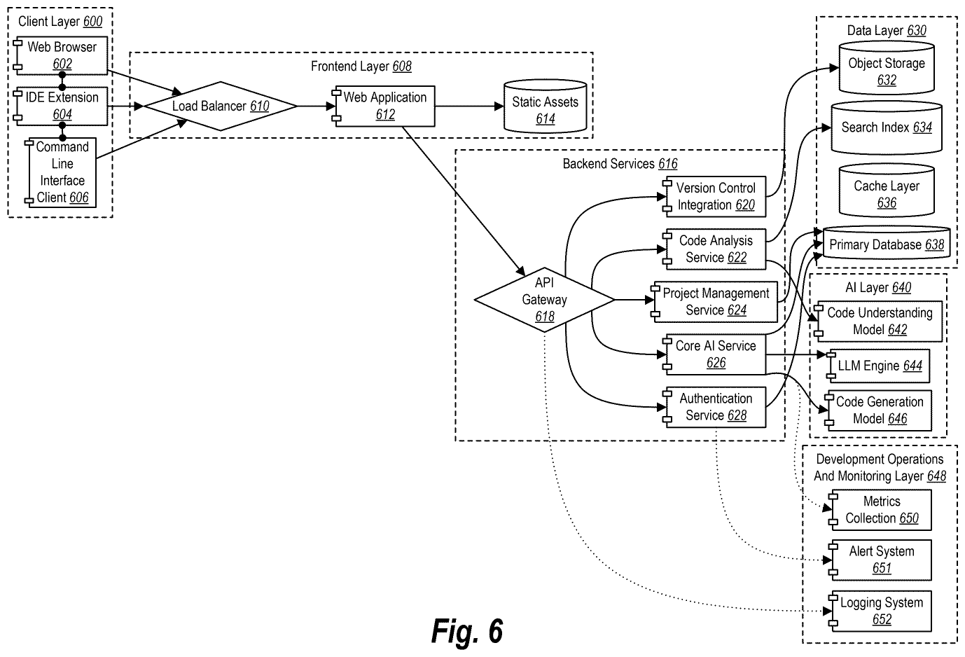

FIG. 6 illustrates architectural details of the autonomous software agent system 100 using one or more machine learning models in accordance with one or more embodiments. In particular, the autonomous software agent system 100 deploys an autonomous software agent with a plurality of computer software composition tools, generates one or more artificial intelligence outputs responsive to a software task, and provides responses to prompts submitted via an interface.

As shown in FIG. 6, the autonomous software agent system 100 contains a client layer 600 (e.g., with a web browser 602, an IDE extension 604, and a command line interface client 606), a frontend layer 608 with a load balancer 610 (e.g., which is a system to distribute incoming traffic across multiple servers which optimizes efficiency), a web application 612 (e.g., a Devin web application that shows a chat interface and the fully featured software composition tools of the autonomous software agent), and static assets 614 (e.g., files that do not dynamically change based on user interactions, such as HTML files, CSS files, JavaScript files, images, etc.).

Moreover, FIG. 6 shows the autonomous software agent system 100 also contains backend services 616 with an API gateway 618 (e.g., which is a single entry point for managing and routing API requests from client devices to different microservices/backend systems), a version control integration 620 (e.g., a backend service application to track changes to code such as a connected code repository application part of a code repository management system), a code analysis service 622, a project management service 624 (e.g., a software system to track the development of various tasks that a software development team is working on), a core AI service 626 (e.g., artificial intelligence modules or tools to handle the use of machine learning models, natural language processing, and other artificial intelligence tasks), and an authentication service 628 (e.g., to check for valid authentication credentials).

In particular, the backend services 616 include applications that all communicate with the backend web-server of the autonomous software agent system 100, which performs the job of deploying autonomous software agents, and orchestrating/managing sessions (Devin sessions), as well as providing the APIs to display data about the autonomous software agent system 100 on various computing devices, generating artificial intelligence outputs, orchestrating the execution of software tasks by accessing a plurality of software composition tools, providing a plurality of interactive tools to a user computing device. In particular, the backend services 616 of the autonomous software agent system 100 manage the generation of artificial intelligence outputs for executing a software task of a development session.

For example, the backend services 616 perform the job of enabling request decomposition, artificial intelligence plan generation, terminal command generation, computer code generation, navigation actions, software task orchestration, and interactive tools of the autonomous software agent. In particular, the client layer 600, the frontend layer 608 and the backend services 616 are in consistent communication with one another to notify each service regarding any input received from a user computing device (e.g., via a chat interface and/or user intervention via interactive tools). Thus, this enables the autonomous software agent system 100 to immediately transfer that input/context to a deployed autonomous software agent.

Further, FIG. 6 shows a data layer 630 with object storage 632 (e.g., which is storage of unstructured data), a search index 634 (e.g., an index of one or more code repositories), a cache layer 636 (e.g., a layer that temporarily holds frequently accessed or recently computed data), and a primary database 638 (e.g., a central data store to hold application data). Moreover, FIG. 6 shows an AI layer 640 with a code understanding model 642, an LLM engine 644, and a code generation model 646. Moreover, FIG. 6 shows a development operations and monitoring layer 648 (e.g., with metrics collection 650, an alert system 651, and a logging system 652).

As shown in FIG. 6, the autonomous software agent system 100 utilizes the AI layer 640 to perform a variety of reasoning/generation tasks. In particular, the autonomous software agent system 100 accesses the AI layer 640 every time a code repository is connected or updated, or a new session is spun up (e.g., each time a new development box is activated). In order to enable the AI layer 640, the autonomous software agent system 100 provides various onboarding tools to a user computing device. In particular, the onboarding tools allow a user to provide access to a code repository provider (e.g., a Gitprovider), select repositories, assign read access, and assign write access.

In some embodiments, the autonomous software agent system 100 prompts a user computing device for additional access permissions. In particular, the autonomous software agent system 100 can prompt the user for additional access permissions after generating a response to a prompt or during an autonomous software agent session. For example, the autonomous software agent system 100 determines during generating a response or executing software coding tasks that additional knowledge/permissions are needed to more thoroughly respond/perform a task.

As further shown in FIG. 6, the AI layer 640 of the autonomous software agent system 100 further includes the code understanding model 642. In particular, the code understanding model 642 analyzes computer code. In other words, the autonomous software agent system 100 seeks to understand the context and background of a code base/repository to generate an index of the code repository (e.g., to more effectively perform software coding tasks as a driver and not merely as a co-pilot).

In some embodiments, the autonomous software agent system 100 extracts contextual data from information provided by a user to generate an index using the code understanding model 642. To illustrate, the autonomous software agent system 100 parses through a code repository and generates abstraction summaries using the code understanding model 642 and one or more additional artificial intelligence models (e.g., such as the LLM engine).

Moreover, the autonomous software agent system 100 utilizes the AI layer 640 to enable AI-native features in a planner interface, a chat interface, or a configuration interface of an autonomous software agent. In particular, the autonomous software agent system 100 provides the AI-native features as options for a user computing device to activate during configuration or during interaction with the autonomous software agent system 100.

In some embodiments, the autonomous software agent system 100 uses the AI layer 640 to ingest data from a code base and further utilizes the code understanding model 642 to generate output predictions related to the context of the code base. For example, the autonomous software agent system 100 connects to code repositories and creates knowledge inputs/suggestions based on processing the information in the code repository.

To illustrate, the autonomous software agent system 100 can read through documentation/specifications and distill that information into data that is relevant for the code understanding model 642 of the autonomous software agent system 100. In addition, after generating the index of the code repository, the autonomous software agent system 100 further stores the index in the data layer 630 and/or uses the development operations and monitoring layer 648 to monitor changes/thresholds related to the connected code repository. This allows the autonomous software agent system 100 to more effectively execute software coding tasks when deploying an autonomous software agent.

Moreover, after generating the index of the code repository, the autonomous software agent system 100 further generates a response to prompts. In some embodiments, the autonomous software agent system 100 receives prompts from the frontend layer 608 submitted via an interface (or where the autonomous software agent system 100 intakes a prompt, whether via the web application, a messaging application, or otherwise) and they are sent to the backend services 616 of the autonomous software agent system 100, where the prompt is processed by the one or more artificial intelligence components (e.g., Devin's brain).

As shown in FIG. 6, the autonomous software agent system 100 utilizes the client layer 600 to receive interactions. In particular, users can submit a prompt or a question regarding a current development session, past development session, a code repository, etc. via a Devin messaging application integration, an application programming interface call, or directly through a web browser application of the intelligent search interface. In some embodiments, the messaging application integration lets users prompt the autonomous software agent system 100 and further create sessions by tagging an autonomous software agent in their team's messaging server.

As just mentioned, the messaging application integration allows for development sessions to be created by tagging/mentioning an autonomous software agent. In some embodiments, the autonomous software agent system 100 receives from a third-party messaging application between a plurality of users, a mention that tags the autonomous software agent to execute the software task. Additionally, the autonomous software agent system 100 transmits the mention that tags the autonomous software agent to a virtual private cloud that hosts the independent virtual. This is shown in more detail below.

In some embodiments, as shown, the autonomous software agent system 100 utilizes the LLM engine 644 (e.g., a model that selects one or more large language models according to certain parameters/requirements) of an autonomous software agent to generate a response to a prompt. In particular, the autonomous software agent system 100 calls a first large language model for a first task (e.g., generating a first result for a prompt) and a second large language model for a second task (generating a second result for the prompt).

In one or more embodiments, the autonomous software agent system 100 utilizes the complex architectural design shown in FIG. 6. In particular, the autonomous software agent system 100 includes a natural language processing component (e.g., Devin's Brain) that allows the autonomous software agent system 100 to understand natural language descriptions (e.g., the functionalities of desired software programs). In some embodiments, the autonomous software agent system 100 utilizes natural language processing to analyze natural language descriptions in a prompt and to extract key functionalities and requirements.

In one or more embodiments, the autonomous software agent system 100 generates an index of a code repository (e.g., accessible by an autonomous software agent) as described in application Ser. No. 19/224,222 PROVIDING INTELLIGENT SEARCH FUNCTIONALITY OF A CODE REPOSITORY VIA AN AUTONOMOUS SOFTWARE AGENT which was filed on May 30, 2025, and is fully incorporated by reference herein.

As mentioned above, in some embodiments, the autonomous software agent system 100 generates a response to the prompt and uses the context from the response to deploy an autonomous software agent. In some embodiments, the autonomous software agent system 100 uses the autonomous software agent system 100 to spin up a development box, where each spun up development box contains knowledge and the autonomous software agent system from one session to another does not transfer the knowledge over to the next session. In some embodiments, knowledge is a form of “information” that allows the autonomous software agent system 100 to retrieve information based on specific triggers that might be relevant to the session. As also mentioned, this knowledge (depending on the trigger) is retrievable across all sessions.

As mentioned above, the autonomous software agent system 100 uses the autonomous software agent system 100 which deploys autonomous software agents that have access to their own machines. In particular, for each new spun up session, the autonomous software agent system 100 spins up a new development box (e.g., sandbox) which includes a fully featured IDE (shell, an editor, a browser, etc.). Moreover, the autonomous software agent system 100 allows a development box to be customized in a user's workspace (e.g., Devin's Workspace), where the user can save a specific machine snapshot that the autonomous software agent system 100 will use each time it spins up a new development box.

Furthermore, the autonomous software agent system generates development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In rolling back to an earlier point in time, the autonomous software agent system 100 rolls back both the state of “Devin's brain” (e.g., the knowledge and the progress on a certain task), as well as the state of Devin's machine (e.g., the machine contents).

Moreover, in some embodiments, the autonomous software agent system 100 offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant.

Furthermore, each of these development boxes (or sessions) can speak to the customer-hosted services (connected via API integrations). Accordingly, the autonomous software agent system 100 can leverage the AI layer 640, the data layer 630, the backend services 616, and the frontend layer 608 to cause the graphical user interface on the user computing device to display the actions taken by the autonomous software agent (e.g., the actions via the software composition tools of the autonomous software agent).

Further, as already mentioned, the autonomous software agent system 100 includes machine learning models. In particular, the autonomous software agent system 100 utilizes pre-trained machine learning models to translate descriptions (e.g., from a response to a prompt) into artificial intelligence outputs (e.g., artificial intelligence plans, computer code, terminal commands, navigation actions, etc.). Moreover, the machine learning models utilized by the autonomous software agent system 100 have been trained on vast amounts of computer code data, which allows them to identify patterns and generate functional code. In some embodiments, the autonomous software agent system 100 utilizes the machine learning models to process the extracted information (e.g., key functionalities and requirements). In particular, the autonomous software agent system 100 utilizes the machine learning models to search for patterns and identify similar code structures from their training data.

Additionally, the autonomous software agent system 100 includes the code generation model 646. In particular, based on processed information from the natural language processing and the machine learning models, the autonomous software agent system 100 translates the descriptions into actual computer code. In other words, the output of the natural language processing and the machine learning model is pulled into the code generation engine to create viable computer code. In some embodiments, based on identified patterns, the autonomous software agent system 100 utilizes the code generation engine to create functional code responsive to deploying an autonomous software agent after generating a response to a prompt.

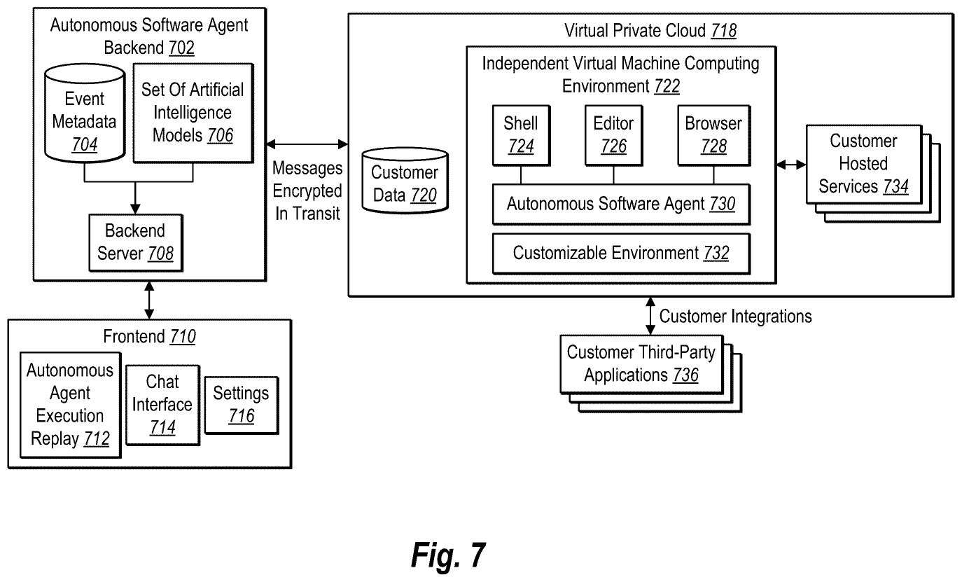

FIG. 7 illustrates additional details of the architecture of the autonomous software agent system 100 in accordance with one or more embodiments. For example, FIG. 7 shows that for each session of deploying an autonomous software agent, the autonomous software agent system 100 spins up/deploys an autonomous software agent backend 702 that includes a “backend container” paired with “a development box” virtual machine. In other words, the autonomous software agent system 100 initializes a development box (e.g., an independent virtual machine computing environment) with an autonomous software agent backend that includes a set of artificial intelligence models 706. As mentioned above, the set of artificial intelligence models 706 contains one or more machine learning/artificial intelligence models shown above used to process, analyze, and generate data.

As shown in FIG. 7, the autonomous software agent backend 702 includes event metadata 704 (e.g., context surrounding a prompt/request submitted to a web application interface, a response to the prompt, or other external sources that contain contextual data), the set of artificial intelligence models 706 (e.g., one or more machine learning models shown and discussed in FIG. 6), and a backend server 708 (e.g., a server that handles logic, database interactions, authentication, and other services for deploying an autonomous software agent).

Further, FIG. 7 shows the autonomous software agent backend 702 interacting with a frontend 710 which includes autonomous agent execution replay 712 (e.g., replay for a timelapse of a development session, a session replay that is a recording of previous user interactions with the autonomous software agent system 100), chat UI 714 (e.g., the graphical user interface provided to a user to submit prompts), and settings 716 (e.g., custom settings established by the autonomous software agent system 100 or by a user).

Moreover, the autonomous software agent backend 702 communicates with a virtual private cloud 718 (e.g., a customer virtual private cloud, which is a dedicated and isolated virtual network within a public cloud service) via encrypted messages. In particular, FIG. 7 shows an independent virtual machine computing environment 722 hosted on the virtual private cloud 718 and the virtual private cloud 718 further includes customer data 720.

Additionally, the independent virtual machine computing environment 722 further includes a shell 724, an editor 726 (e.g., integrated development environment), a browser 728, an autonomous software agent 730, a customizable environment 732 (e.g., playbooks, knowledge, etc. that customize an independent virtual machine computing environment) and customer hosted services 734 (e.g., services or applications hosted and managed by a tenant organization). Additionally, FIG. 7 shows that the virtual private cloud 718 can integrate various applications via access tokens/API keys. In particular, the autonomous software agent system can use the independent virtual machine computing environment 722 (e.g., the autonomous software agent) to write various code and make integrations with applications integrated with the virtual private cloud 718 (e.g., customer third-party applications 736).

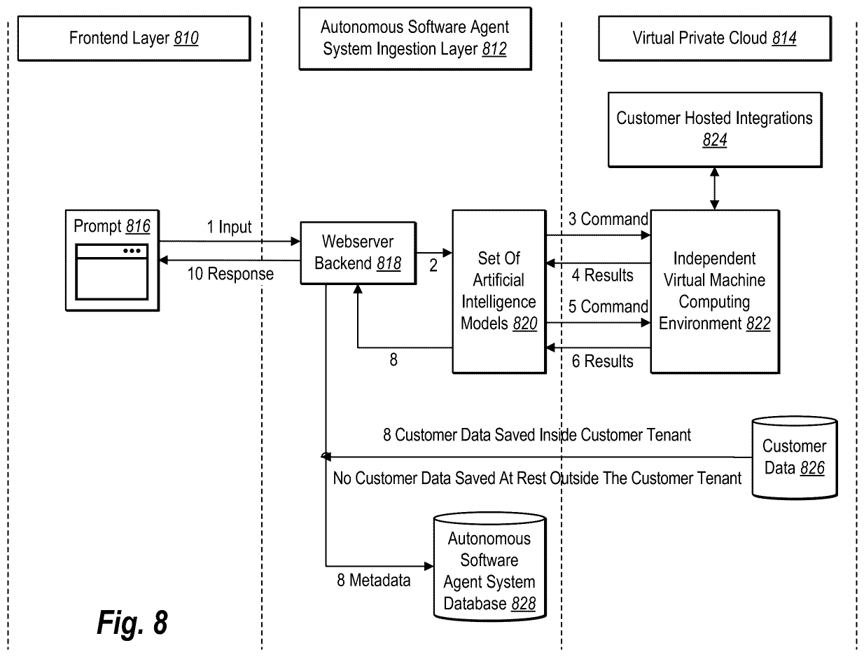

Further, FIG. 8 shows that the autonomous software agent system 100 receives a prompt 816 via a frontend layer 810. As shown, the autonomous software agent system 100 passes the prompt 816 to an autonomous software agent system ingestion layer 812. In response to the prompt 816, the autonomous software agent system 100 responds to the prompt 816 with a webserver backend 818 and further passes the information to a set of artificial intelligence models 820 (e.g., one or more artificial intelligence models shown above in FIG. 6).

As further shown in FIG. 8, the autonomous software agent system 100 passes commands/results back and forth between a virtual private cloud 814 (e.g., an independent virtual machine computing environment 822) and the set of artificial intelligence models 820. In other words, FIG. 8 illustrates the interaction between the frontend layer 810 of the autonomous software agent system 100, the backend of the autonomous software agent system 100, and an autonomous software agent deployed for performing tasks at the virtual private cloud 814. Furthermore, the independent virtual machine computing environment 822 also accesses customer hosted integrations 824 at the virtual private cloud 814.

Additionally, FIG. 8 shows customer data 826 at the virtual private cloud 814 which the autonomous software agent system 100 passes all customer data saved inside the customer tenant to the tenant (e.g., and no customer data is saved at rest outside the customer tenant). Moreover, FIG. 8 shows the autonomous software agent system 100 using the webserver backend 818 to pass metadata to an autonomous software agent system database 828.

In one or more embodiments, the autonomous software agent system 100 receives an autonomous software agent prompt and deploys an autonomous software agent, which includes one or more machine learning components (e.g., large language models). In one or more embodiments, the autonomous software agent system 100 utilizes a text encoder to generate a set of text tokens for the autonomous software agent prompt.

Moreover, based on the text tokens, the autonomous software agent system 100 generates an artificial intelligence plan (e.g., breaks down the software task), and further reasons how to complete one or more tasks. In particular, the autonomous software agent system uses the independent virtual machine computing environment 822 to communicate with the set of artificial intelligence models 820 (e.g., the artificial intelligence components shown in FIG. 6) to determine which shell commands to make, computer code to write (e.g., in the editor), and webpages to browse.

In one or more embodiments, the autonomous software agent system 100 further utilizes a text encoder to process a prompt/request to deploy an autonomous software agent. In particular, the text encoder includes a component of a neural network to transform textual data (e.g., the text prompt) into a numerical representation. For instance, the autonomous software agent system 100 utilizes the text encoder to transform the prompt into a text encoding (e.g., text tokens). Further, the autonomous software agent system 100 utilizes the text encoder in a variety of ways.

For instance, the autonomous software agent system 100 utilizes the text encoder to i) determine the frequency of individual words in the text prompt (e.g., each word becomes a feature vector), ii) determine a weight for each word within the text prompt to generate a text vector that captures the importance of words within a text prompt, iii) generate low-dimensional text vectors in a continuous vector space that represents words within the text prompt, and/or iv) generate contextualized text vectors by determining semantic relationships between words within the text prompt.

Furthermore, although not shown in FIGS. 7-8, in one or more embodiments, the autonomous software agent system trains the set of artificial intelligence models 820 (e.g., artificial intelligence components such as the code generation engine, the natural language processing, and the machine learning models). For example, the autonomous software agent system 100 leverages a set of large language models and fine-tunes each large language model for different tasks. In particular, the autonomous software agent system 100 has a large language model for terminal requests, a large language model for generating computer code, a large language model for generating a plan, and a large language model for performing website browsing actions and determining a relevance of certain portions of a website domain page.

Moreover, the autonomous software agent system 100 trains the set of artificial intelligence models 820 by sending an input task to one or more of the large language models, generates a prediction for the input task, and compares the prediction with a ground truth reference. Based on the comparison, the autonomous software agent system 100 fine-tunes or modifies parameters of one or more large language models (e.g., that are part of the set of artificial intelligence models 820). Thus, at inference time, the autonomous software agent system 100 performs advanced reasoning tasks fine-tuned for specific use cases.

In addition, as alluded to above, the autonomous software agent system 100 trains machine learning models to translate descriptions into code. In some embodiments, the autonomous software agent system 100 trains multiple machine learning models for discrete tasks. In particular, the autonomous software agent system 100 trains a machine learning model to generate specific types of functional code. For example, the autonomous software agent system 100 utilizes a machine learning model to generate computer code from a description and compares the description to a ground truth reference and fine-tunes/modifies parameters of the machine learning model.

Moreover, the autonomous software agent system 100 further continuously learns from feedback and developer interactions. In particular, the autonomous software agent system 100 deploys autonomous software agents that perform a variety of tasks, and in response to prompts and/or feedback (e.g., user intervention), the autonomous software agent system 100 learns from the interactions to improve its capabilities. In other words, the autonomous software agent system 100 fine-tunes the artificial intelligence components in response to updates/feedback received from users.

FIGS. 7-8 describe various architectural details of the autonomous software agent system 100. In particular, the architectural components of the autonomous software agent system 100 enable an autonomous software agent to perform a variety of tasks. To illustrate, the autonomous software agent system 100 performs repetitive coding tasks such as generating boilerplate code, data validation routines, and unit tests.

Moreover, the autonomous software agent system 100 performs code reviews (e.g., one or more software developers examine code written by others to identify potential issues and provide feedback) and debugging such as analyzing code to identify potential bugs and suggesting fixes/improvements. Furthermore, the autonomous software agent system 100 performs deployment automation to automate a deployment process of software (e.g., streamlining the transition from development to production).

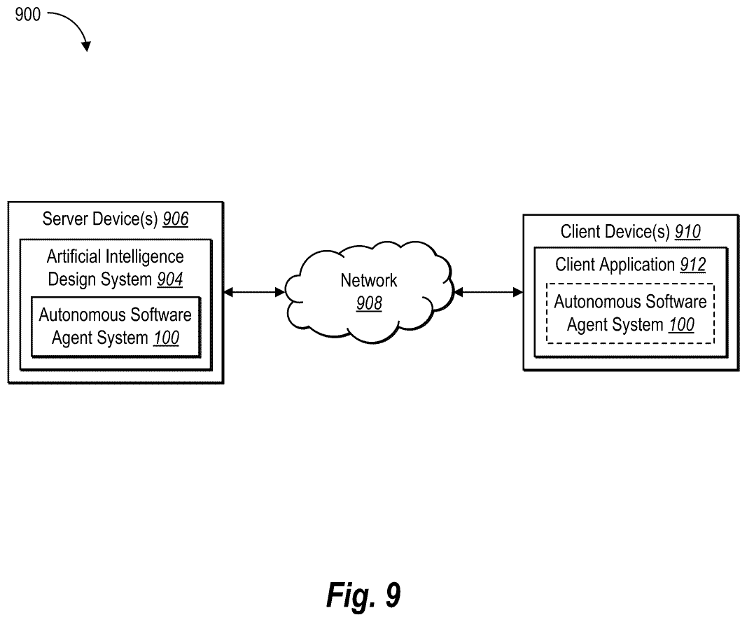

Additional details regarding the autonomous software agent system 100 will now be provided with reference to the figures. For example, FIG. 9 illustrates a schematic diagram of an exemplary system environment 900 in which an autonomous software agent system 100 operates. As illustrated in FIG. 9, the system environment 900 includes server device(s) 906, an artificial intelligence design system 904, a network 908, and client device(s) 910. Additionally, FIG. 9 illustrates that the artificial intelligence design system 904 includes the autonomous software agent system 100.

Although the system environment 900 of FIG. 9 is depicted as having a particular number of components, the system environment 900 is capable of having a different number of additional or alternative components (e.g., a different number of servers, client devices, or other components in communication with the autonomous software agent system 100 via the network 908). Similarly, although FIG. 9 illustrates a particular arrangement of the server device(s) 906, the network 908, and the client device(s) 910, various additional arrangements are possible.

The server device(s) 906, the network 908, and the client device(s) 910 are communicatively coupled with each other either directly or indirectly (e.g., through the network 908 discussed in greater detail below). Moreover, the server device(s) 906 and the client device(s) 910 include one or more of a variety of computing devices (including one or more computing devices as discussed in greater detail below).

As mentioned above, the system environment 900 includes the server device(s) 906. In one or more embodiments, the server device(s) 906 process input for a request (e.g., a request to configure an autonomous software agent or to deploy an autonomous software agent). In one or more embodiments, the server device(s) 906 comprise a data server. In some implementations, the server device(s) 906 comprise a communication server or a web-hosting server. Furthermore, the server device(s) 906 can be associated with the autonomous software agent system 100 or with an organization/company that deploys the autonomous software agent system 100.

In some embodiments, the client device(s) 910 includes computing devices associated with the one or more user accounts that submit requests for the autonomous software agent system 100. In some embodiments, the autonomous software agent system 100 trains one or more artificial intelligence models such as a code understanding model, one or more large language models, and a code generation model.

In one or more embodiments, the client device(s) 910 includes smartphones, tablets, desktop computers, laptop computers, head-mounted-display devices, or other electronic devices. The client device(s) 910 includes one or more software applications (e.g., the client application 912) for generating content in accordance with the artificial intelligence design system 904. In one or more embodiments, the client application 912 includes a software application hosted on the server device(s) 906 accessible by the client device(s) 910 through another application, such as a web browser.

To provide an example implementation, in some embodiments, the autonomous software agent system 100 on the server device(s) 906 supports the autonomous software agent system 100 on the client device(s) 910. For instance, in some cases, the artificial intelligence design system 904 on the server device(s) 906 gathers data for the autonomous software agent system 100. In response, the autonomous software agent system 100, via the server device(s) 906, provides the information to the client device(s) 910. In other words, the client device(s) 910 obtains (e.g., downloads) the autonomous software agent system 100 from the server device(s) 906 that is already trained/optimized. Once downloaded, the autonomous software agent system 100 on the client device(s) 910 is able to perform tasks (e.g., generative software tasks) independent from the server device(s) 906. In one or more alternative implementations, the autonomous software agent system 100 generates or learns parameters for one or more artificial intelligence models (e.g., used to implement an autonomous software agent) in whole or in part on the client device(s) 910.

In alternative implementations, the artificial intelligence design system 904 includes a web hosting application that allows the client device(s) 910 to interact with content and services hosted on the server device(s) 906. To illustrate, in one or more implementations, the client device(s) 910 accesses a software application supported by the server device(s) 906. In response, the artificial intelligence design system 904 on the server device(s) 906 provides tools for monitoring/modifying/generating computer code using the autonomous software agent. In other words, the client device(s) 910 does not have to download the autonomous software agent system 100 while still being able to access/utilize the trained/optimized tools provided by the artificial intelligence design system 904 via a web hosting application.

In some embodiments, the autonomous software agent system 100 is implemented in whole, or in part, by the individual elements of the system environment 900. For instance, although FIG. 9 illustrates the autonomous software agent system 100 implemented or hosted on the server device(s) 906, different components of the autonomous software agent system 100 are able to be implemented by a variety of devices within the system environment 900. For example, one or more (or all) components of the autonomous software agent system 100 are implemented by a different computing device or a separate server from the server device(s) 906. Indeed, as shown in FIG. 9, the client device(s) 910 includes the autonomous software agent system 100.

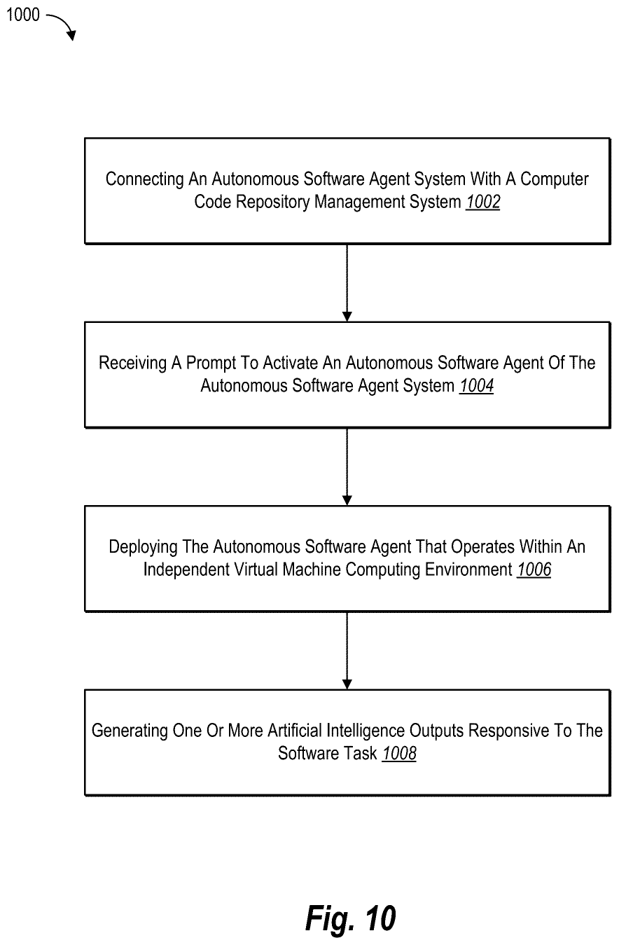

FIG. 10 illustrates a flowchart of a series of acts 1000 for generating artificial intelligence outputs responsive to the software task based on accessing the one or more code repositories in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts of FIG. 10 are performed as part of a computer-implemented method. Alternatively, a non-transitory computer-readable medium stores instructions thereon that, when executed by at least one processor, cause a computing device to perform the acts of FIG. 10. In some embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of connecting an autonomous software agent system with a computer code repository management system. Further, the series of acts 1000 includes an act 1004 of receiving a prompt to activate an autonomous software agent of the autonomous software agent system. Moreover, the series of acts 1000 includes an act 1006 of deploying the autonomous software agent that operates within an independent virtual machine computing environment. Additionally, the series of acts 1000 includes an act 1008 of generating one or more artificial intelligence outputs responsive to the software task.

In particular, the act 1002 includes connecting an autonomous software agent system with a computer code repository management system comprising one or more code repositories. Further, the act 1004 includes receiving, via a graphical user interface, a prompt to activate an autonomous software agent of the autonomous software agent system to execute a software task. Moreover, the act 1006 includes in response to the prompt, deploying the autonomous software agent that operates within an independent virtual machine computing environment to execute the software task by accessing the one or more code repositories. Additionally, the act 1008 includes generating, utilizing the autonomous software agent, one or more artificial intelligence outputs responsive to the software task based on accessing the one or more code repositories. The series of acts 1000 also includes the below clauses.
Clause 1. A computer-implemented method comprising: connecting an autonomous software agent system with a computer code repository management system comprising one or more code repositories; receiving, via a graphical user interface, a prompt to activate an autonomous software agent of the autonomous software agent system to execute a software task; in response to the prompt, deploying the autonomous software agent that operates within an independent virtual machine computing environment to execute the software task by accessing the one or more code repositories; and generating, utilizing the autonomous software agent, one or more artificial intelligence outputs responsive to the software task based on accessing the one or more code repositories.
Clause 2. The computer-implemented method of clause 1, wherein connecting the autonomous software agent system with the computer code repository management system comprises: providing, for display in the graphical user interface, an option to select a subset of repositories of a plurality of code repositories corresponding to the computer code repository management system; and providing, for display in the graphical user interface, an additional option to select the plurality of code repositories corresponding to the computer code repository management system.
Clause 3. The computer-implemented method of any of clauses 1-2, wherein connecting the autonomous software agent system with the computer code repository management system comprises providing, for display in the graphical user interface, permission options to grant the autonomous software agent system a level of access to the one or more code repositories of the computer code repository management system.
Clause 4. The computer-implemented method of any of clauses 1-3, wherein connecting the autonomous software agent system with the computer code repository management system comprises providing a read access level or a write access level for the autonomous software agent to access the one or more code repositories of the computer code repository management system.
Clause 5. The computer-implemented method of any of clauses 1-4, wherein receiving the prompt to activate the autonomous software agent to execute a software task comprises receiving the prompt that mentions a specific code repository of the computer code repository management system that was connected with the autonomous software agent system.
Clause 6. The computer-implemented method of any of clauses 1-5, further comprising: providing, for display in the graphical user interface, an option to delegate the one or more code repositories of the computer code repository management system to one or more pre-defined organization groups; receiving, via the graphical user interface, a delegation of a first code repository to a first pre-defined organization group; and receiving, via the graphical user interface, an additional delegation of a second code repository to a second pre-defined organization group.
Clause 7. The computer-implemented method of any of clauses 1-6, further comprising receiving a signing key for the autonomous software agent system writing computer code in the one or more code repositories of the computer code repository management system.
Clause 8. The computer-implemented method of any of clauses 1-7, further comprising updating the one or more code repositories of the computer code repository management system to include the one or more artificial intelligence outputs based on the autonomous software agent writing the one or more artificial intelligence outputs that is responsive to the software task.
Clause 9. A system comprising: one or more memory devices; and one or more processors coupled to the one or more memory devices, configured to cause the system to: connect an autonomous software agent system with a computer code repository management system by: receiving repository access for the autonomous software agent system to access a code repository of the computer code repository management system; and receiving at least one of read access or write access for the autonomous software agent system to read or write computer code in the code repository; in response to a prompt to execute a software task, deploy an autonomous software agent of the autonomous software agent system to execute the software task; and generate, utilizing the autonomous software agent, one or more artificial intelligence outputs responsive to the software task based on at least one of the autonomous software agent reading computer code within the code repository or writing additional computer code within the code repository.
Clause 10. The system of clause 9, wherein the one or more processors are configured to cause the system to: receive read access for the autonomous software agent to read the computer code in the code repository of the computer code repository management system; and receive write access for the autonomous software agent to write additional computer code in an additional code repository of the computer code repository management system.
Clause 11. The system of any of clauses 9-10, wherein the one or more processors are configured to cause the system to generate the one or more artificial intelligence outputs by reading the computer code in the code repository and writing the additional computer code in the additional code repository.
Clause 12. The system of any of clauses 9-11, wherein the one or more processors are configured to cause the system to: receive write access for the autonomous software agent to write computer code in the code repository, wherein the write access allows the autonomous software agent to contribute to the code repository; generate, utilizing the autonomous software agent, the one or more artificial intelligence outputs based on the write access of the autonomous software agent; and generating, utilizing the autonomous software agent, a pull request.
Clause 13. The system of any of clauses 9-12, wherein the one or more processors are configured to cause the system to: receive a pull request template corresponding to the code repository of the computer code repository management system; generate the pull request according to the pull request template and the one or more artificial intelligence outputs; and submit the pull request to the computer code repository management system.
Clause 14. The system of any of clauses 9-13, wherein the one or more processors are configured to cause the system to: receive a signing key for the autonomous software agent system writing computer code in a code repository of the computer code repository management system; and generate, utilizing the autonomous software agent, a pull request comprising the one or more artificial intelligence outputs.
Clause 15. The system of any of clauses 9-14, wherein the one or more processors are configured to cause the system to: submit the pull request to the computer code repository management system; receive approval of the pull request comprising the one or more artificial intelligence outputs to be merged with the computer code in the code repository; and merge the one or more artificial intelligence outputs and the signing key into the code repository.
Clause 16. A non-transitory computer-readable medium storing executable instructions which, when executed by at least one processing device, cause the at least one processing device to perform operations comprising: connecting an autonomous software agent system with a computer code repository management system comprising a plurality of code repositories by: receiving repository access for the autonomous software agent system to access a subset of code repositories of the plurality of code repositories; receiving write access for the autonomous software agent system to write computer code in the subset of code repositories; and receiving a signing key for the autonomous software agent system writing computer code in the subset of code repositories; in response to a prompt to execute a software task, deploy an autonomous software agent of the autonomous software agent system to execute the software task; and updating the subset of code repositories to include one or more artificial intelligence outputs based on the autonomous software agent writing the one or more artificial intelligence outputs that is responsive to the software task.
Clause 17. The non-transitory computer-readable medium of clause 16, further comprising: searching a pull request template library to identify a pull request template for a first artificial intelligence output; and identifying the pull request template corresponding to the first artificial intelligence output.
Clause 18. The non-transitory computer-readable medium of any of clauses 16-17, further comprising: generating a pull request according to the pull request template and the first artificial intelligence output; submitting the pull request to the computer code repository management system; generating an additional pull request according to an additional pull request template and a second artificial intelligence output; and submitting the additional pull request to the computer code repository management system.
Clause 19. The non-transitory computer-readable medium of any of clauses 16-18, further comprising updating the subset of code repositories to include the first artificial intelligence output, the second artificial intelligence output, and the signing key for the autonomous software agent.
Clause 20. The non-transitory computer-readable medium of any of clauses 16-19, further comprising: providing the autonomous software agent access to a plurality of software composition tools comprising a shell tool, a browser tool, an integrated development environment, and a planner tool; and generating, utilizing the autonomous software agent to access the plurality of software composition tools and the subset of code repositories, the one or more artificial intelligence outputs.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

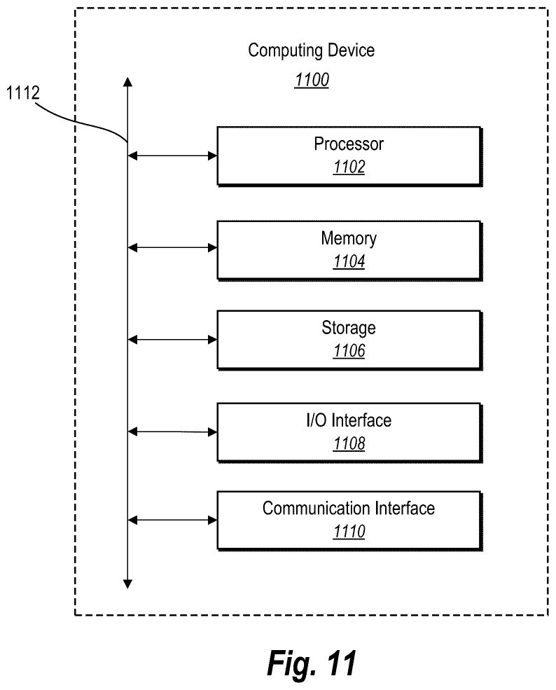

FIG. 11 illustrates a block diagram of an example computing device 1100 that may be configured to perform one or more of the processes described above. One will appreciate that one or more computing devices, such as the computing device 1100 may represent the computing devices described above (e.g., the server device(s) 906 and/or the client device(s) 910). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 include hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
connecting an autonomous software agent system with a computer code repository management system comprising one or more code repositories;
receiving, via a graphical user interface, a prompt to activate an autonomous software agent of the autonomous software agent system to execute a software task;
in response to the prompt, deploying the autonomous software agent that operates within an independent virtual machine computing environment to execute the software task by accessing the one or more code repositories; and
generating, utilizing the autonomous software agent, one or more artificial intelligence outputs responsive to the software task based on accessing the one or more code repositories.

2. The computer-implemented method of claim 1, wherein connecting the autonomous software agent system with the computer code repository management system comprises:
providing, for display in the graphical user interface, an option to select a subset of repositories of a plurality of code repositories corresponding to the computer code repository management system; and
providing, for display in the graphical user interface, an additional option to select the plurality of code repositories corresponding to the computer code repository management system.

3. The computer-implemented method of claim 1, wherein connecting the autonomous software agent system with the computer code repository management system comprises providing, for display in the graphical user interface, permission options to grant the autonomous software agent system a level of access to the one or more code repositories of the computer code repository management system.

4. The computer-implemented method of claim 1, wherein connecting the autonomous software agent system with the computer code repository management system comprises providing a read access level or a write access level for the autonomous software agent to access the one or more code repositories of the computer code repository management system.

5. The computer-implemented method of claim 1, wherein receiving the prompt to activate the autonomous software agent to execute a software task comprises receiving the prompt that mentions a specific code repository of the computer code repository management system that was connected with the autonomous software agent system.

6. The computer-implemented method of claim 1, further comprising:
providing, for display in the graphical user interface, an option to delegate the one or more code repositories of the computer code repository management system to one or more pre-defined organization groups;
receiving, via the graphical user interface, a delegation of a first code repository to a first pre-defined organization group; and
receiving, via the graphical user interface, an additional delegation of a second code repository to a second pre-defined organization group.

7. The computer-implemented method of claim 1, further comprising receiving a signing key for the autonomous software agent system writing computer code in the one or more code repositories of the computer code repository management system.

8. The computer-implemented method of claim 1, further comprising updating the one or more code repositories of the computer code repository management system to include the one or more artificial intelligence outputs based on the autonomous software agent writing the one or more artificial intelligence outputs that is responsive to the software task.

9. A system comprising:
one or more memory devices; and
one or more processors coupled to the one or more memory devices, configured to cause the system to:
connect an autonomous software agent system with a computer code repository management system by:
receiving repository access for the autonomous software agent system to access a code repository of the computer code repository management system; and
receiving at least one of read access or write access for the autonomous software agent system to read or write computer code in the code repository;
in response to a prompt to execute a software task, deploy an autonomous software agent of the autonomous software agent system to execute the software task; and
generate, utilizing the autonomous software agent, one or more artificial intelligence outputs responsive to the software task based on at least one of the autonomous software agent reading computer code within the code repository or writing additional computer code within the code repository.

10. The system of claim 9, wherein the one or more processors are configured to cause the system to:
receive read access for the autonomous software agent to read the computer code in the code repository of the computer code repository management system; and
receive write access for the autonomous software agent to write additional computer code in an additional code repository of the computer code repository management system.

11. The system of claim 10, wherein the one or more processors are configured to cause the system to generate the one or more artificial intelligence outputs by reading the computer code in the code repository and writing the additional computer code in the additional code repository.

12. The system of claim 9, wherein the one or more processors are configured to cause the system to:
receive write access for the autonomous software agent to write computer code in the code repository, wherein the write access allows the autonomous software agent to contribute to the code repository;
generate, utilizing the autonomous software agent, the one or more artificial intelligence outputs based on the write access of the autonomous software agent; and
generating, utilizing the autonomous software agent, a pull request.

13. The system of claim 12, wherein the one or more processors are configured to cause the system to:
receive a pull request template corresponding to the code repository of the computer code repository management system;
generate the pull request according to the pull request template and the one or more artificial intelligence outputs; and
submit the pull request to the computer code repository management system.

14. The system of claim 9, wherein the one or more processors are configured to cause the system to:
receive a signing key for the autonomous software agent system writing computer code in a code repository of the computer code repository management system; and
generate, utilizing the autonomous software agent, a pull request comprising the one or more artificial intelligence outputs.

15. The system of claim 14, wherein the one or more processors are configured to cause the system to:
submit the pull request to the computer code repository management system;
receive approval of the pull request comprising the one or more artificial intelligence outputs to be merged with the computer code in the code repository; and
merge the one or more artificial intelligence outputs and the signing key into the code repository.

16. A non-transitory computer-readable medium storing executable instructions which, when executed by at least one processing device, cause the at least one processing device to perform operations comprising:
connecting an autonomous software agent system with a computer code repository management system comprising a plurality of code repositories by:
receiving repository access for the autonomous software agent system to access a subset of code repositories of the plurality of code repositories;
receiving write access for the autonomous software agent system to write computer code in the subset of code repositories; and
receiving a signing key for the autonomous software agent system writing computer code in the subset of code repositories;
in response to a prompt to execute a software task, deploy an autonomous software agent of the autonomous software agent system to execute the software task; and
updating the subset of code repositories to include one or more artificial intelligence outputs based on the autonomous software agent writing the one or more artificial intelligence outputs that is responsive to the software task.

17. The non-transitory computer-readable medium of claim 16, further comprising:
searching a pull request template library to identify a pull request template for a first artificial intelligence output; and
identifying the pull request template corresponding to the first artificial intelligence output.

18. The non-transitory computer-readable medium of claim 17, further comprising:
generating a pull request according to the pull request template and the first artificial intelligence output;
submitting the pull request to the computer code repository management system;
generating an additional pull request according to an additional pull request template and a second artificial intelligence output; and
submitting the additional pull request to the computer code repository management system.

19. The non-transitory computer-readable medium of claim 18, further comprising updating the subset of code repositories to include the first artificial intelligence output, the second artificial intelligence output, and the signing key for the autonomous software agent.

20. The non-transitory computer-readable medium of claim 16, further comprising:
providing the autonomous software agent access to a plurality of software composition tools comprising a shell tool, a browser tool, an integrated development environment, and a planner tool; and
generating, utilizing the autonomous software agent to access the plurality of software composition tools and the subset of code repositories, the one or more artificial intelligence outputs.
